(19) United States
(12) Patent Application Publication
(10) Pub. No.: US 2013/0332204 A1
(43) Pub. Date: Dec. 12, 2013

(54) SYSTEM AND METHOD FOR GENERATION OF CUSTOMIZED INSURANCE PROPOSALS

(71) Applicants: Bruce Fiori, Farmington, CT (US); Saleh A. Alsubai, West Hartford, CT (US); Jon C. Desjardins, Hebron, CT (US); Jack W. Cassada, East Hartford, CT (US)

(72) Inventors: Bruce Fiori, Farmington, CT (US); Saleh A. Alsubai, West Hartford, CT (US); Jon C. Desjardins, Hebron, CT (US); Jack W. Cassada, East Hartford, CT (US)

(21) Appl. No.: 13/837,103

(22) Filed: Mar. 15, 2013

Related U.S. Application Data
(63) Continuation-in-part of application No. 12/915,468, filed on Oct. 29, 2010.
(60) Provisional application No. 61/385,272, filed on Sep. 22, 2010.

(51) Int. Cl. G06Q 40/08

(52) U.S. Cl. CPC G06Q 40/08
USPC 705/4

(57) ABSTRACT

A computer system includes a web server component and a rules engine component in communication with the web server component. The rules engine component receives input rating information that is relevant to insurance coverage rating decisions. The rules engine component applies rating rules to the input rating information to generate premium quotations for a proposed insurance policy. The web server component downloads a quotation display page to a client computer, including an option to generate a customized proposal based on the premium quotations for said proposed insurance policy.

### CROSS-REFERENCE TO RELATED APPLICATION

This application claims benefit of and priority to U.S. patent application Ser. No. 12/915,468 filed on Oct. 29, 2010 and U.S. provisional patent application Ser. No. 61/385,272, filed Sep. 22, 2010, the contents of each of which are hereby incorporated by reference in their entirety for all purposes.

### FIELD

The present invention relates to computer systems for receiving applications for insurance policies. More particularly, embodiments relate to computer systems for generating customized proposals for insurance policies.

### BACKGROUND

Many requests for insurance policies are placed with insurance companies by independent agents who represent the prospective insureds. A significant part of the agents' activities includes comparing quotations from one insurance company to another to determine what policy coverage is available for what premium amounts.

It is known for insurance companies to operate web server computers that host websites that can be accessed by insurance agents for the purpose of obtaining premium quotations, and for other purposes, including actual purchase of insurance policies. However, existing insurance company websites for agents may lack features that would enhance the agents' opportunities to provide the best service for the prospective insureds.

### SUMMARY

An apparatus, method, computer system and computer-readable data storage medium are disclosed which include a web server component which hosts webpages and which downloads the webpages to client computers in response to requests from the client computers. The web server computer may be operated by or on behalf of an insurance company.

The apparatus, method, computer system and computer-readable data storage medium may also include a proposal engine component that is coupled to the web server component. The proposal engine component receives input quotation information from the web server component. The input quotation information is associated with at least a first insurance product quotation. The proposal engine component includes a processor programmed to apply proposal rules to the at least first insurance product quotation to generate a proposal for a prospective insured relating to the at least first insurance product quotation.

The web server component is responsive to the proposal engine component and the input quotation to generate user interfaces to allow a user to further refine components of a proposal package. The components of the proposal package may include pricing information, marketing materials, upsell options and customization selected by or provided through the user interface.

With these methods and systems, an agent or other user may be aided in the creation of complex, complete and accurate proposals based on insurance quotations.

With these and other advantages and features of the invention that will become hereinafter apparent, the invention may be more clearly understood by reference to the following detailed description of the invention, the appended claims, and the drawings attached hereto.

### BRIEF DESCRIPTION OF THE DRAWINGS

FIG. 1 schematically illustrates a business environment in which the present invention may be applied.

FIG. 2 is a block diagram that illustrates a computer system provided in accordance with aspects of the present invention.

FIG. 3 is a block diagram that illustrates a server computer that is a component of the computer system of FIG. 2.

FIG. 4 is a block diagram that illustrates software aspects of the computer system of FIG. 2.

FIG. 5 is a high level flow chart that illustrates a process performed in the computer system of FIG. 2.

FIG. 6 is a more detailed flow chart illustrating the process of FIG. 5.

FIG. 7 is an example screen display that may be provided to a user in conjunction with the process of FIGS. 5 and 6.

FIG. 8 is a further example screen display that may be provided to a user in conjunction with the process of FIGS. 5 and 6.

FIG. 9 is a further example screen display that may be provided to a user in conjunction with the process of FIGS. 5 and 6.

FIG. 10 is a further example screen display that may be provided to a user in conjunction with the process of FIGS. 5 and 6.

FIG. 11 is a further example screen display that may be provided to a user in conjunction with the process of FIGS. 5 and 6.

FIG. 12 is a further example screen display that may be provided to a user in conjunction with the process of FIGS. 5 and 6.

FIG. 13 is a further example screen display that may be provided to a user in conjunction with the process of FIGS. 5 and 6.

FIG. 14 is a further example screen display that may be provided to a user in conjunction with the process of FIGS. 5 and 6.

FIG. 15 is a further example screen display that may be provided to a user in conjunction with the process of FIGS. 5 and 6.

FIG. 16 is a further example screen display that may be provided to a user in conjunction with the process of FIGS. 5 and 6.

FIG. 17 is a further example screen display that may be provided to a user in conjunction with the process of FIGS. 5 and 6.

FIG. 18 is a further example screen display that may be provided to a user in conjunction with the process of FIGS. 5 and 6.

FIG. 19 is a further example screen display that may be provided to a user in conjunction with the process of FIGS. 5 and 6.

FIG. 20 is a further example screen display that may be provided to a user in conjunction with the process of FIGS. 5 and 6.

FIG. 21 is a further example screen display that may be provided to a user in connection with the process of FIGS. 5 and 6.

FIG. 22 is a flow chart that illustrates additional aspects of the process depicted in FIG. 6.

FIG. 23 is a flow chart that illustrates a process for generating a proposal that is performed in the computer system of FIG. 2.

FIG. 24A is a flow chart that illustrates a process for performing an expanded coverage process performed in the computer system of FIG. 2.

FIG. 24B is a flow chart that illustrates a process for finalizing a proposal package performed in the computer system of FIG. 2.

FIG. 25 is an example screen display that may be provided to a user in connection with the processes of FIGS. 23-24.

FIG. 26 is an example of a portion of a proposal generated pursuant to some embodiments.

FIG. 27 is a further example of a portion of a proposal generated pursuant to some embodiments.

FIG. 28 is a further example of a portion of a proposal generated pursuant to some embodiments.

FIG. 29 is a further example of a portion of a proposal generated pursuant to some embodiments.

FIG. 30 is a further example of a portion of a proposal generated pursuant to some embodiments.

FIG. 31 is an example screen display that may be provided to a user in connection with the process of FIGS. 23-24.

FIG. 32 is a further example screen display that may be provided to a user in connection with the process of FIGS. 23-24.

FIG. 33 is a further example screen display that may be provided to a user in connection with the process of FIGS. 23-24.

### DETAILED DESCRIPTION

In general, and for the purposes of introducing concepts of embodiments of the present invention, a website hosted by an insurance company's computer allows insurance agents to submit “new business” (i.e., requests for new insurance policies) to the insurance company. The website facilitates input by the agent of information required for the insurance company to provide one or more premium quotations for a proposed new insurance policy. The information identifies the prospective insured and indicates attributes of the insured that are relevant to pricing the proposed coverage. The information also indicates parameters for the proposed policy. The website allows the agent to present alternatives with respect to some of the information, such as alternative policy limits and/or deductible amounts. Based on the alternative policy parameters, the website may present alternative quotations to the agent in a side-by-side format for easy comparison by the agent.

Pursuant to some embodiments, the agent may interact with the website to generate complex proposals for prospective insureds based on a selected quotation as well as other parameters selected by the agent.

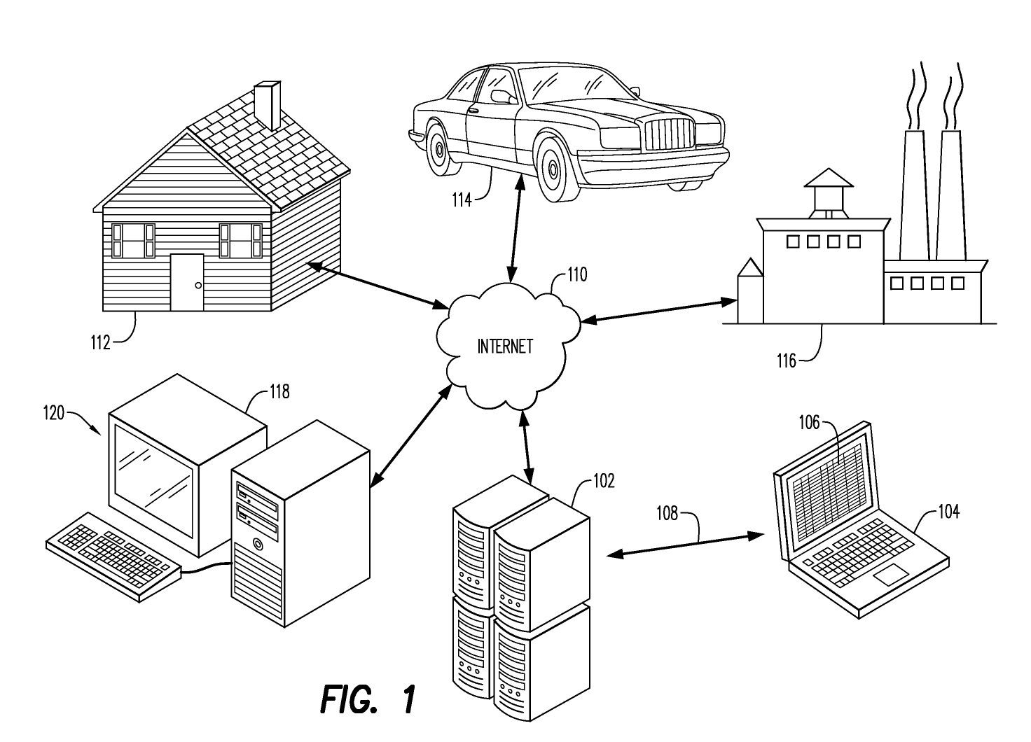

FIG. 1 schematically illustrates a business environment in which the present invention may be applied.

In example embodiments described herein, the present invention relates to a computer system by which an insurance company may receive requests from independent insurance agents for issuance of insurance policies.

FIG. 1 schematically shows aspects of an insurance business. As is customary, the insurance company in question operates one or more central computers, including server computer 102 shown in FIG. 1. Other computers deployed in the insurance company may include personal/notebook computers assigned to individual employees (such as employees who make underwriting decisions, as discussed below), including the computer indicated by reference numeral 104. One function that may be performed by the computer 104 is displaying report data 106 that has been downloaded to the computer 104 from the server computer 102 via a communication path 108.

The server computer 102 may also exchange information with other parties, including for example holders of insurance policies issued by the insurance company. This exchange of information may occur via private and/or public data communication networks, including the Internet (reference numeral 110). Such policy holders may include owners of residential properties 112, who are covered under homeowner's insurance policies; owners of motor vehicles 114 who are covered by motor vehicle liability and/or property damage policies; and large commercial/industrial enterprises, such as the corporate owner of a factory 116. Workers' compensation coverage may be among the types of insurance that the insurance company provides to factory owners and other business enterprises.

Still further, the insurance company may have contractual relationships with numerous independent insurance agencies that place and provide services for policies written by the insurance company. Thus the server computer 102 may engage in data communication with computers 118 operated by the company's agents. As indicated at 120, the insurance agent computer 118 includes a screen display by which the agent can view information downloaded to the insurance agent computer 118 from the insurance company server computer 102. As described in more detail herein, the insurance company server computer 102 may host a website by which the independent agents may place new insurance policies with the insurance company. The types of information that may be exchanged between the insurance agents and the insurance company may include insurance premium quotations downloaded from the insurance company in response to inquiries from the insurance agents. Also, the insurance premium quotations from the insurance company may be downloaded to one or more computers (not shown) operated by so-called “multicarrier platforms” (i.e., aggregators of quotes from multiple insurance companies).

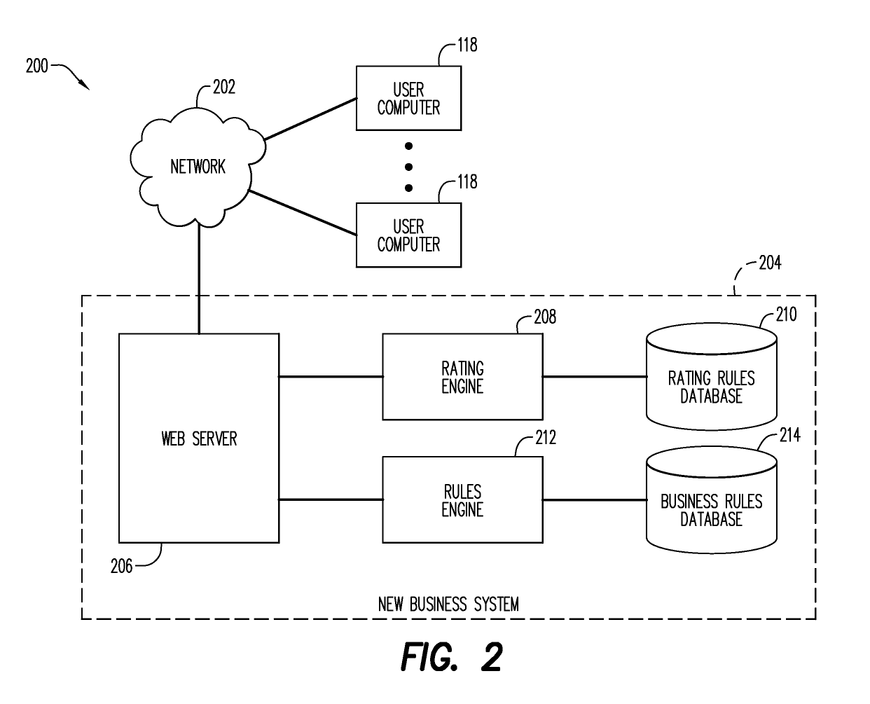

FIG. 2 is a block diagram that illustrates a computer system 200 provided in accordance with aspects of the present invention.

Reference numeral 202 in FIG. 2 represents the Internet or other public or private data communications network. As in FIG. 1, reference numeral 118 indicates computers (e.g., conventional personal computers) operated by insurance agents and used for various purposes, including interaction with a web server computer 206 that is operated by an insurance company for the purpose of receiving and accepting requests for issuance of new insurance policies. It will be noted that the agent computers 118 and the web server computer 206 are coupled to the data communication network 202 to permit data communication among the computers. The agent computers 118 may run conventional software, including a conventional web browser computer program which permits each agent computer 118 to access websites, including one or more websites hosted by the web server computer 206.

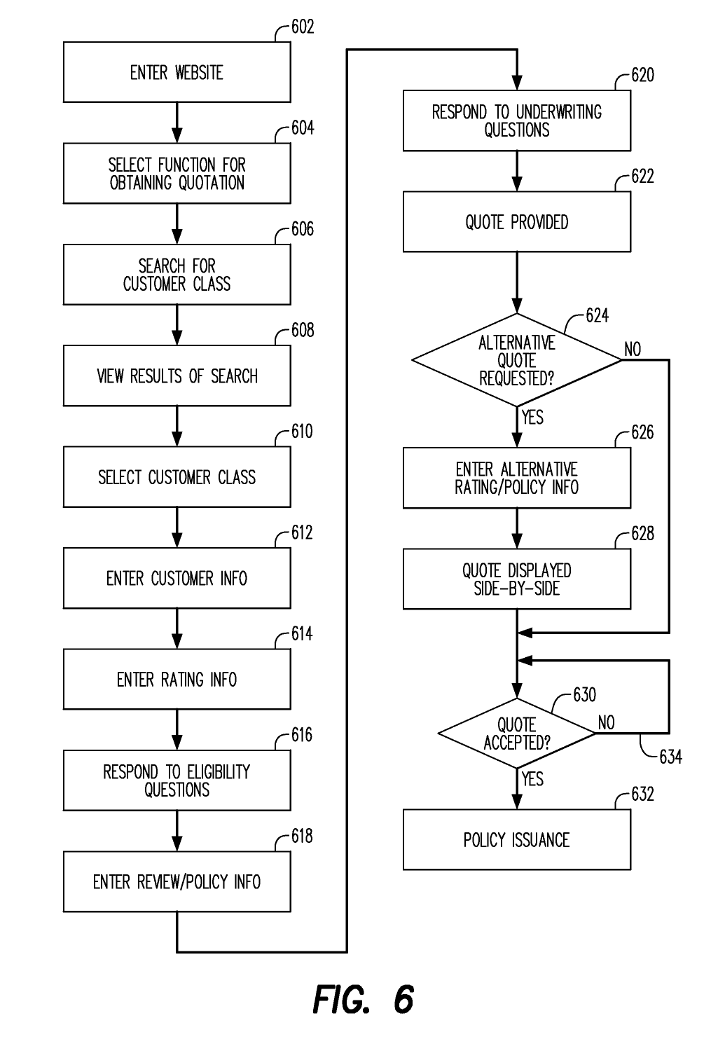

As depicted in FIG. 2, the web server computer 206 may be a part of a larger computer system, indicated by reference numeral 204, and hereinafter referred to as the “new business computer system”. The web server computer 206 may encompass suitable hardware and software resources for hosting a website made up of a number of webpages. Details of the website and webpages will be described below, particularly with reference to FIGS. 6-32. The web server computer 206 stores and generates the webpages and downloads the pages on request to the agent computers 118. Thus it will be appreciated that the agent computers 118 may function as client computers that are served by the web server computer 206.

Also shown in FIG. 2 is a rating engine component 208 that is part of the new business computer system 204 and is in communication with the web server computer 206. The rating engine component 208 may receive information entered into data entry form pages provided by the web server computer 206 to the agent computers 118. The information may be relevant to proposed insurance coverage and may be entered by insurance agents who operate the agent computers 118. The rating rules engine component 208 may include a computer processor (not separately shown in FIG. 2) that is programmed to apply rating rules to the information provided by the insurance agents concerning the proposed insurance coverage. As will be seen, the rating rules engine component 208 may generate insurance premium quotations that are downloaded to the agent computers 118 via the web server computer 206.

FIG. 2 also shows a rating rules database 210 as part of the new business computer system 204. The rating rules database 210 is in communication with the rating rules engine component 208 and stores the rating rules applied by the rating rules engine component 208. The rating rules database 210 may include one or more data storage devices (not shown in FIG. 2 apart from block 210) in which the rating rules are stored.

Also shown in FIG. 2 as part of the new business computer system 204 is a rules engine component 212. The rules engine component 212 is in communication with the web server computer 206. As discussed in more detail below, the rules engine component 212 applies business rules to make automatic underwriting decisions on requests for insurance policies and/or to determine whether the requests should be referred to a human underwriter. If the rules engine component 212 determines that the request qualifies for automatic underwriting, and a positive underwriting decision, then certain premium quotations generated by the rating engine component may be presented to the user/agent as “bindable”—i.e., immediately available for acceptance by the agent/user. The rules engine component 212 may make these determinations, based on business rules stored in a business rules database 214. The business rules database 214 is also part of the new business computer system 204 and is in communication with the rules engine component 212.

In addition, the rules engine component may make other rules-based decisions, as described below, based on business rules stored in the business rules database 214.

Also shown in FIG. 2 as part of the new business computer system 204 is a proposal engine component 216. The proposal engine component 216 is in communication with the web server computer 206. As discussed in more detail below, the proposal engine component 216 applies one or more proposal rules to allow the generation, assembly and customization of complex proposals for transmission to a prospective insured. As will be described further below, the proposal engine component 216 operates based on information from the rating engine component 208 and the rules engine component 212 (which may be determined during a quoting process as described herein) to allow an agent to generate a detailed proposal for a quote to be provided to a prospective insured. As will be described further herein, the proposal engine component 216 may cause the generation, selection and creation of a number of different pieces of information in a proposal, including forms, marketing flyers or brochures, payment options, calculated payment schedules, cross-sell or promotional information, or the like. Further, rules associated with a proposal rules database 218 may be applied to ensure the proposal is generated pursuant to one or more proposal rules, allowing the proposal to be tailored to a specific agent and insured.

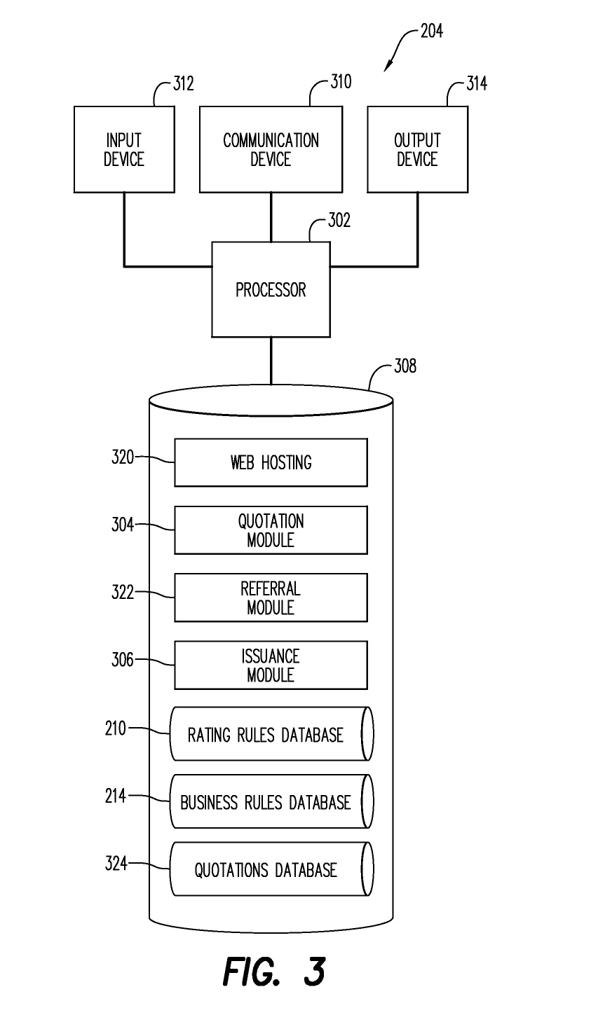

FIG. 3 is a block diagram representation of the new business computer system 204. The new business computer system 204 may be conventional in terms of its hardware aspects.

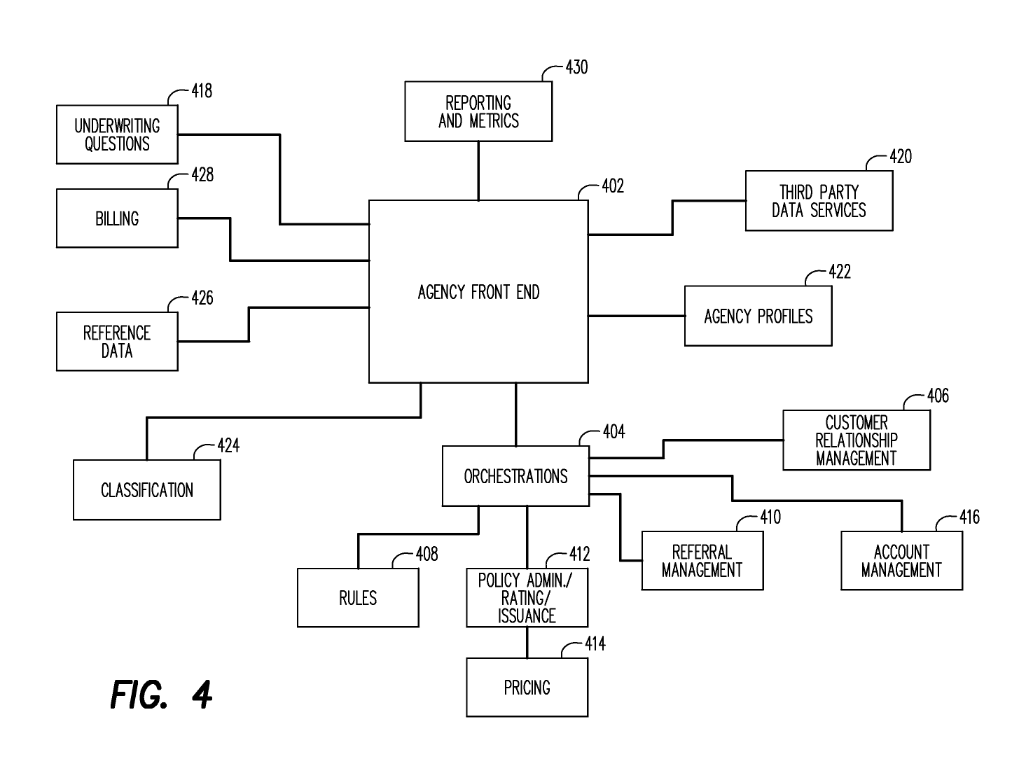

Although the new business computer system 204 is depicted as a single integrated system in FIGS. 2 and 3, it may alternatively be implemented as two, three or more networked computer systems, as described for example in the discussion of FIG. 4 as set forth below.

As depicted in FIG. 3, the new business computer system 204 includes a processor 302, which may be constituted by one or more conventional computer processors. The new business computer system 204 further includes a quotation module 304, which generates premium quotations for proposed new insurance policies, as briefly discussed above and as described in more detail below. The quotation module 304 may be constituted, at least in part, by the processor 302 in combination with suitable software program instructions. Thus the quotation module may be represented as a software application program stored on a storage device 308. Aspects of the software program instructions for the quotation module 304 will be described below.

The new business computer system 204 also includes a policy issuance module 306, which operates to issue insurance policies requested by the insurance agents via their agent computers 118. The policy issuance module 306 may operate in a generally conventional manner, and may be constituted, at least in part, by the processor 302 in combination with suitable software instructions. Accordingly, the policy issuance module 306 may be represented as a software application program stored on the storage device 308.

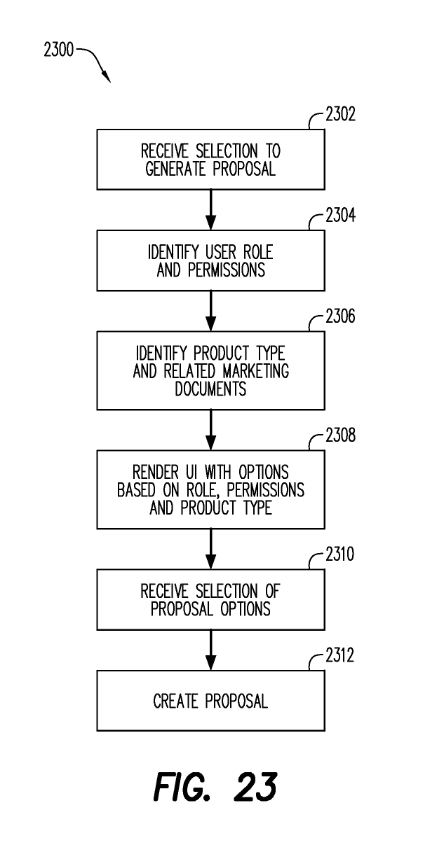

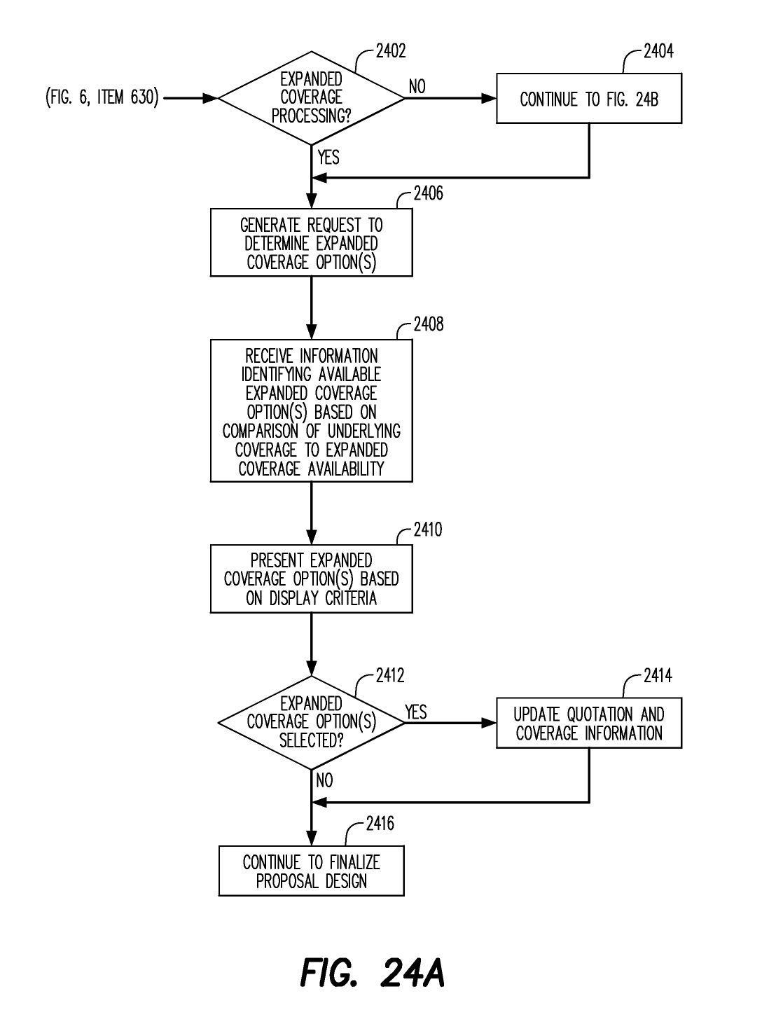

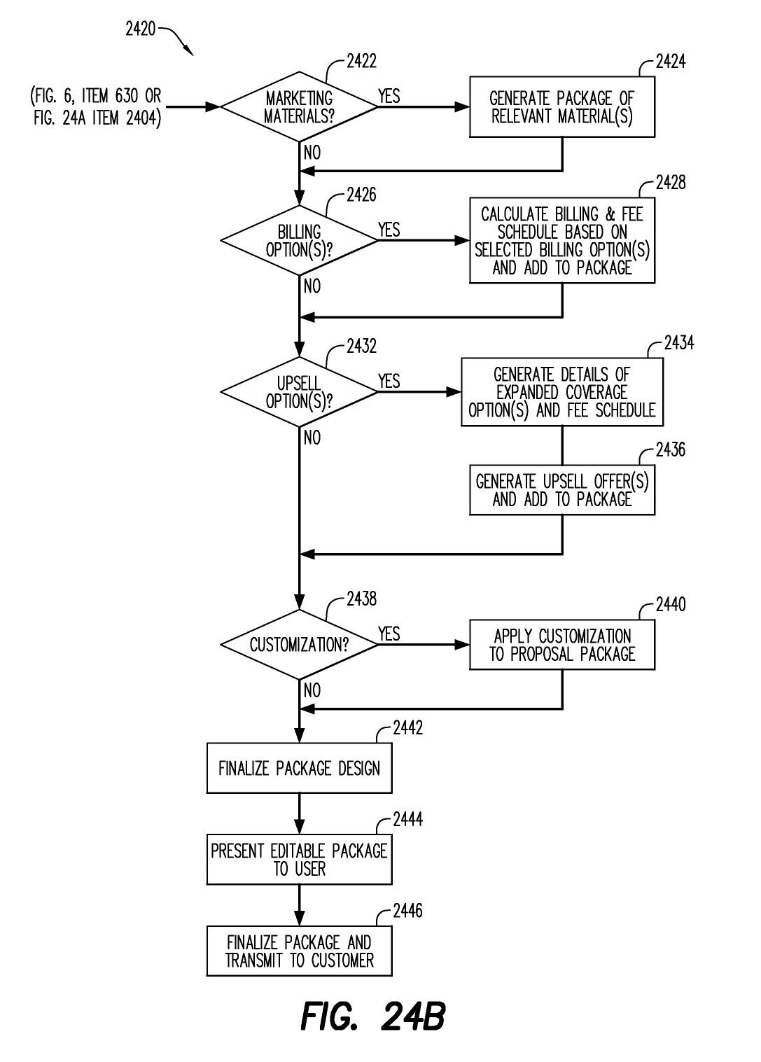

Pursuant to some embodiments, the new business computer system 204 also includes a proposal module 326 (which may be, for example, generally equivalent to the proposal engine 216 of FIG. 2), which operates to generate proposals for insurance policies for which quotations have been generated by quotation module 304. The proposal module 326 may operate as described further herein (for example, the module may be configured to perform the processing described in conjunction with FIGS. 23-24 described below). The proposal module 326 may be constituted at least in part by the processor in combination with suitable software instructions and may, as a result, be represented as a software application program stored on the storage device 308.

It will be understood that the new business computer system 204 also includes one or more storage devices, represented by item 308 in FIG. 3. The storage devices 308 are coupled for data communication with the processor 302 and may comprise any appropriate information storage device, including combinations of magnetic storage devices (e.g., magnetic tape and hard disk drives), optical storage devices, and/or semiconductor memory devices (such as Random Access Memory (RAM) devices and Read Only Memory (ROM) devices). At least some of these devices may be considered computer-readable storage media, or may include such media. The storage devices 308 may store the above-mentioned software program instructions and/or other program instructions to control the processing module 302 such that the new business computer system 204 provides desired functionality, as described herein. Thus, the storage devices 308 store one or more programs for controlling the processing module 302. The processing module 302 performs instructions of the programs, and thereby operates in accordance with aspects of the present invention. In some embodiments, the programs may include one or more conventional operating systems (not shown). The programs may further include application programs such as a conventional data communication program and a conventional database management program. The programs stored in the storage devices 308 may also include conventional web hosting software (block 320). In addition, the storage devices 308 may store an application program 322 to implement at least some aspects of the rules engine 212 (FIG. 2), including software to determine when a request for quotation should be referred to a human operator.

Still further, the storage devices 308 may store the rating rules database 210, the business rules database 214, and the proposal database 218 as referred to above in connection with FIG. 2. In addition, the storage devices 308 may store a database 324 for storing data relating to pending or outstanding insurance premium quotations. Further, although not shown in FIG. 3, the storage devices 308 (or other storage devices accessible to the system) may store other information associated with proposals, such as, for example, information associated with creative (such as logos or the like), marketing materials (such as flyers or offers), cross-sell information (including, for example, the conditions or rules associated with presenting any such cross-sell information as well as the cross-sell offers), or forms (such as electronic funds transfer forms, or the like).

Continuing to refer to FIG. 3, the new business computer system 204 may further include one or more communication devices 310 coupled to the processor 302. The communication devices 310 may function to facilitate communication with, for example, other devices (such as the agent computers 118). In addition, the new business computer system 204 may include one or more input devices 312 such as a keyboard, a keypad, a mouse or other pointing device, a microphone, knob or a switch, an infra-red (IR) port, a docking station and/or a touch screen. The input device(s) 312 may be coupled to the processor 302. Still further the new business computer system 204 may include one or more output devices 314, such as a display (e.g., a display screen), a speaker, and/or a printer. The output devices 314 may also be coupled to the processor 302.

In a practical embodiment of the invention, the insurance company may introduce the website for serving insurance agents within a complex environment that includes legacy computing systems and software resources. Accordingly, the system representations that appear in FIGS. 1-3 may be considered to be somewhat simplified or abstract. In practice, the computing resources required to provide the functionality described herein may be more complex than is indicated in FIGS. 1-3, and may encompass several server computers running a variety of application programs that interact with each other and provide a variety of functions. Thus, FIG. 4 illustrates a software environment in which the present invention may be implemented. While each block in FIG. 4 is indicative of a particular software resource and/or application program, it should be understood that these software resources may collectively run on a number of inter-networked server computers and/or storage devices, which are not separately depicted. Some of the software resources shown in FIG. 4 may be legacy or pre-existing resources, while others may have been provided for the purposes of implementing the user front end that is described herein.

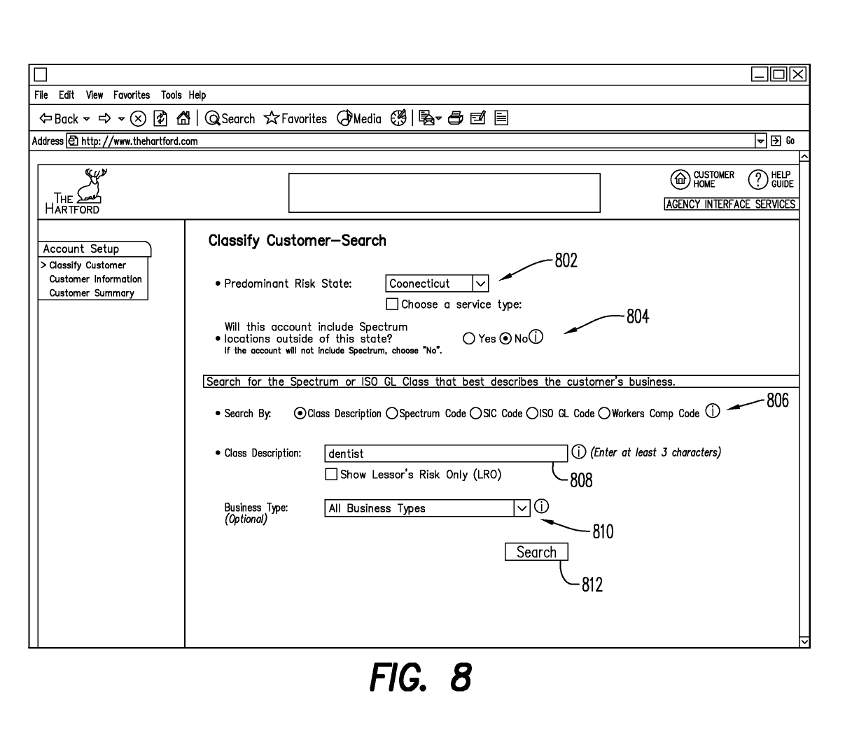

Referring then to FIG. 4, block 402 represents an agency front end application program. The agency front end application 402 is central to providing the functionality described herein, and may for example be implemented by configuring and/or extending a commercially available software program in accordance with teachings of this disclosure. One suitable commercially available software program is known as “Agency Portal”, published by Sword Group, Saint-Didier-au-Mont-d'Or, France. Among other functions, the agency front end application 402 may facilitate inputting of information into standard formats prescribed by ACORD (the Association for Cooperative Operations Research and Development—an insurance industry standards body). An example sequence of display screens that may be provided by the agency front end application 402 in accordance with aspects of the present invention is illustrated in FIGS. 8-21 and 25-32 and will be discussed below.

Block 404 in FIG. 4 represents software that handles orchestration of interactions between the agency front end application 402 and other software resources upon which the agency front end application 402 relies. One function of the orchestrations software 404 is to serve as an interface between the agency front end application 402 and a legacy customer relationship management application, indicated at 406. One possible example of a suitable customer relationship management application is known as “Siebel” and is commercially available from Oracle.

Functions that may be performed by the customer relationship management application 406 may include keeping track of contacts related to policy holders and prospective policy holders, logging requests for issuance of policies, generating quotations, storing records relating to underwriting decisions and dispositions of requests for policies, logging issuance of policies, and correlating documents related to each policy holder or policy requestor. In support of these functions, the customer relationship management application 406 may maintain and access a customer relationship management database, which is not separately indicated.

The orchestrations software 404 may also apply rules to determine whether underwriting approval can be granted automatically to a request for issuance for a policy, or whether, instead, the request is to be referred to a human underwriter for consideration. The rules to be applied for determining possible automatic underwriting approval or, alternatively, referral to a human underwriter, may be stored in a rules data storage facility 408 that is coupled to the orchestrations software 404. Thus the rules data storage facility 408 may implement at least part of the business rules database 214 shown in FIGS. 2 and 3, and the orchestrations software 404 may implement at least part of the rules engine 212 (FIG. 2) and/or the referral module 322 (FIG. 3).

In addition, the orchestrations software 404 may interface the agency front end application 402 to a referral management application program 410. It will be appreciated that the referral management application program 410 may be invoked by the orchestrations software 404 in cases where the application of the underwriting/referral rules calls for a referral to a human underwriter. The referral management application program 410 may be available for interaction by the underwriter to allow him/her to access information concerning the request from the agent that is relevant to the underwriting decision. The referral management application program 410 may also be the vehicle to allow the underwriter to indicate and document the underwriting decision. An underwriting database, which is not separately shown, may be associated with the referral management application program 410.

The orchestrations software 404 may further provide an interface between the agency front end application 402 and an application program 412 that handles rating, issuance and policy administration tasks. Based on policy and rating information received from the agent via the agency front end application 402, the rating/admin/issuance application 412 may apply rules to determine the premium amount to be quoted for the requested policy. A pricing module 414 may be associated with the rating/admin/issuance application 412 and may supply a risk score for the requested policy as an input to the rating determination. The rating/admin/issuance application 412 also—in response to the agent's indication that the quote is accepted—issues the requested policy and handles administrative tasks relative to the issued policy. Again, suitable databases that are not shown may be maintained and accessed by the rating/admin/issuance application 412.

An account management application program 416 may also be present and interfaced to the agency front end application 402 via the orchestrations software 404.

The agency front end application 402 may also be coupled to other software/data resources without the intermediation of the orchestrations software 404. For example, an underwriting questions service application 418 may be coupled to the agency front end application 402. The underwriting questions service application 418 may store a list or lists of underwriting questions to be posed by the agency front end application 402 to agents with respect to requested policies. The underwriting questions service application 418 may operate based on rules that determine which questions are presented to the agent in various situations, depending on attributes of the prospective insured and/or the requested coverage. Examples of underwriting questions will be discussed below in connection with example screen displays that are illustrated in the drawings.

Also shown in FIG. 4 is a block 420 that represents third party data services that may be accessed by the agency front end application 402 in connection with its handling of agents' requests. These services may, for example, include name and address hygiene and/or fill-in services, distance finding services, and/or services for providing identifying details concerning the agents.

Still further, an agency profile information source 422 may be coupled to the agency front end application 402. The agency profile information source 422 may include one or more databases (not separately shown) that store agency name, status, contact information, etc. with respect to the universe of independent agents authorized to place new business with the insurance company. The agency front end application 402 may retrieve agency profile information from the agency profile information source 422 in order to automatically fill in agency information for policy requests filed by the agents.

Still further, the agency front end application 402 may be coupled to a classification application program 424. The classification application program 424 may supply further information to the agency front end application 402 that is needed in handling agents' requests for insurance policies. For example, the information supplied by the classification application program 424 may include information that identifies the various classifications of insured entities for rating and underwriting purposes. The information supplied by the classification application program 424 may also include data that indicates what “appetite” (i.e., the degree of interest) that the insurance company has with respect to insuring various classifications of insureds.

Similarly, the reference data source 426, also coupled to the agency front end application 402, may provide additional information to which the agency front end application 402 refers while responding to agents' requests for insurance policies.

A conventional billing application program 428 may also be coupled to the agency front end application 402 and may be invoked by the agency front end application 402 upon policy issuance to initiate immediate and ongoing billing of the insured for the issued policy.

Block 430 in FIG. 4 represents a utility program that is coupled to the agency front end application 402. The utility program 430 accumulates statistics and generates reports concerning the activities of the agency front end application 402 in handling policy request transactions.

One or more additional software/hardware resources, which are not shown, may be provided to enforce security requirements with respect to the agency front end application 402 and other resources illustrated in FIG. 4. Preferably the security features of the system allow for single sign in on the part of the user leading to access to all needed resources according to the authorizations assigned to the user.

In at least some cases, the coupling between the agency front end application 402 and other software resources (e.g., blocks 418, 420, 422, 424, 426, 428 and 430) may be via suitable “middleware” programs, which are not explicitly represented in FIG. 4.

The orchestrations software 404 may further provide an interface to proposal generation modules or processes. For example, the orchestrations software 404 may further provide an interface between the agency front end application 402 and an application program 432 that handles billing that allows the front end application to cause a billing or fee schedule to be generated for a policy for which a quotation or proposal is being generated. The orchestrations software 404 may further provide an interface between the agency front end application 402 and an application program 434 that provides a document assembly function for the generation and assembly of a proposal for a prospective insured based on one or more quotations generated using the system. The document assembly function may also provide editing and communication functions allowing an agent or other authorized user to modify certain portions of a proposal prior to transmission to a prospective insured.

Pursuant to some embodiments, the document assembly function may include or be based on a portable document file (“PDF”) assembly and creation engine such as the Adobe LifeCycle® publishing engine. The document assembly function may further be supported by, or in communication with, one or more document assembly data sources or tools such as a creative program 436 that allows the retrieval and insertion of one or more selected logos or other creative collateral based on information associated with a specific proposal being generated. A marketing program 438 may also be provided which allows the retrieval and insertion of one or more appropriate marketing materials relevant to a particular proposal such as, for example marketing flyers or cross-sell information. A security program 440 may be provided which enforces editing and other privileges, allowing the control of whether certain fields, forms, or data elements may be edited by an authorized user during the creation of a proposal.

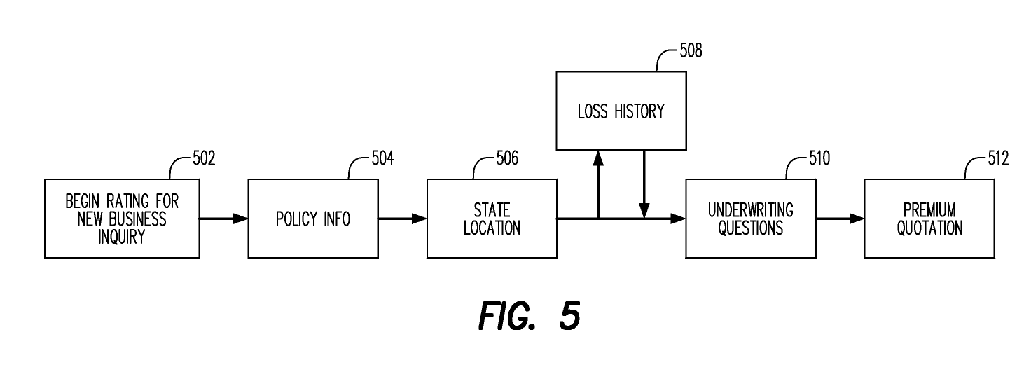

FIG. 5 is a high level flow chart that illustrates a process performed in the computer system 200 of FIG. 2.

Block 502 in FIG. 5 represents the beginning of a process for generating a premium quotation in response to a request for a new insurance policy. It will be appreciated that the request may be received from an insurance agent by the computer system 200 via the above-mentioned agency front end application 402 (FIG. 4).

Continuing to refer to FIG. 5, at 504 information concerning the requested policy is received from the agent via the agency front end application 402. Example details of the requested policy information will be discussed below in connection with FIGS. 6, 13, 14, etc.

At 506, the agent indicates via the agency front end application 402 in what state (i.e., in which state of the United States) the risk to be insured is located. At 508 the computer system 200 diverts from the agency front end application 402 in order to access information that indicates the applicable loss history for the prospective insured.

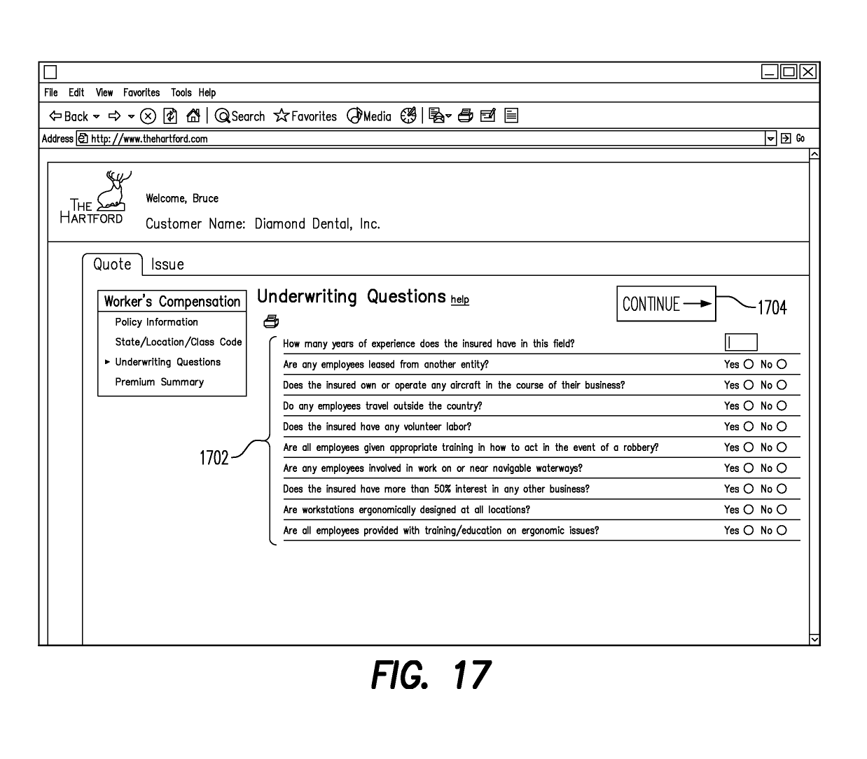

At 510, and again via the agency front end application 402, the computer system 200 poses to the agent a number of underwriting questions. Examples of appropriate underwriting questions will also be discussed below with reference to FIGS. 6 and 17, etc. The underwriting questions may be reflexive in nature, in that a response to a given underwriting question may cause one or more other questions to be presented to the user.

At 512, and based on the information gathered at steps 504-510 (any or all of which information may be considered “rating information”), the computer system 200 generates a premium quotation for the requested policy, and presents the quotation to the agent via the agency front end application 402.

FIG. 6 is a more detailed flow chart illustrating the process of FIG. 5.

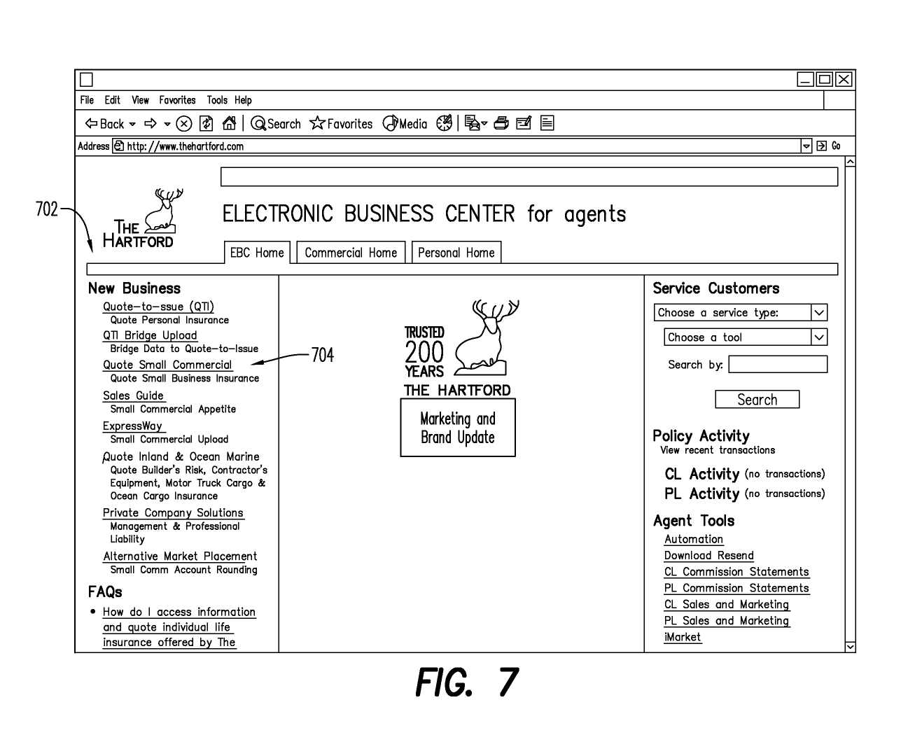

At 602, an agent who is operating one of the agent computers 118 (FIG. 2) accesses the website provided by the agency front end application 402 and the new business computer system 204 (FIG. 2). FIG. 7 is an example welcome screen of a kind that may be downloaded from the new business computer system 204 to the agent computer 118. One salient feature of the screen display of FIG. 7 is the menu 702 provided at the left-hand side of the screen display. Menu option 704 (“Quote Small Commercial”) is of particular relevance for the ensuing discussion which will focus on an example policy request relating to insurance for a small commercial enterprise, and more specifically to workers' compensation coverage for a small commercial enterprise. Accordingly, it is assumed for the purposes of this example that the agent/computer user selects this option 704, thereby selecting (block 604, FIG. 6) a function of the new business computer system 204 by which a premium quotation is requested and obtained.

As a result of the agent/user selecting menu option 704 from the screen display of FIG. 7, the new business computer system 204 and the agency front end application 402 may download to the agent computer 118 a screen display like that shown in FIG. 8. The purpose of the latter screen display is to enable and launch a search (block 606, FIG. 6) for a customer classification that matches the prospective insured represented by the agent/user. The screen display of FIG. 8 includes a drop-down menu 802 that allows the agent/user to specify the state in which the risk/prospective insured is located. At 804, the screen display allows the agent/user to indicate whether the risk is located entirely within the state indicated with the drop-down menu 802. At 806, the screen display allows the agent/user to indicate how the search for the customer classification is to be performed.

The screen display of FIG. 8 also includes a text data entry field 808 into which the agent/user may enter text to identify the type of enterprise that is to be insured. (It will be noted that for this example, the agent/user is assumed to have described the customer as “dentist”.) A “business type” drop-down menu 810 is also provided in the screen display. When the agent/user has completed selection of menu items, entry of data, etc. into the form provided by the screen display, he/she may then launch the search itself by actuating the “search” button 812.

In some embodiments, the set of customer classifications presented for search and/or selection by the agent/user may vary depending on what state the risk is located in. Other options presented to the agent/user and/or types of information solicited from and/or questions posed to the agent/user may vary with the state in which the risk is located.

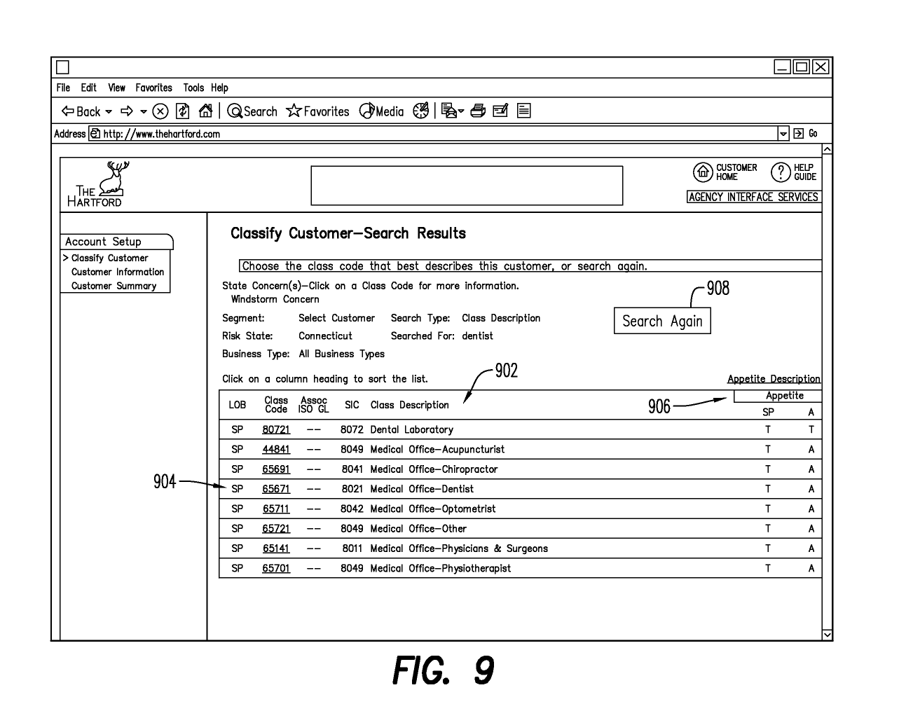

FIG. 9 shows an example screen display that may be downloaded to the agent computer 118 from the new business computer system 204 and the agency front end application 402 to indicate results of the search that was launched at 606 (FIG. 6). With the downloading of the FIG. 9 screen display, the agent/user is allowed to view the customer classification search results, as indicated by block 608 in FIG. 6. Referring to FIG. 9, for the most part the search results consists of a list of customer classification menu items 902 that are “clickable” by the agent/user to indicate which of the customer classifications matches the proposed insured. For purposes of this example, it is assumed that the correct customer classification is the one listed at 904, i.e. class code 65671, “Medical Office-Dentist”.

It will also be noted that the right side of the screen display, at 906, indicates the insurance company's “appetite” for the proposed coverage. In some embodiments, the insurance company's appetite for classes of risks may be divided into four categories—“targeted” (“T”); “accepted” (“A”); “limited” (“L”); and “not acceptable” (“N”).

If the screen display of FIG. 9 lists the correct customer classification (as is assumed to be the case here), then the agent/user can select (click on) the corresponding menu item, thereby effecting selection of that customer classification, as indicated by block 610 in FIG. 6. If the search results did not yield the correct classification, the agent/user is allowed to navigate back to the screen display of FIG. 8 by clicking the “search again” button 908 shown in the screen display of FIG. 9.

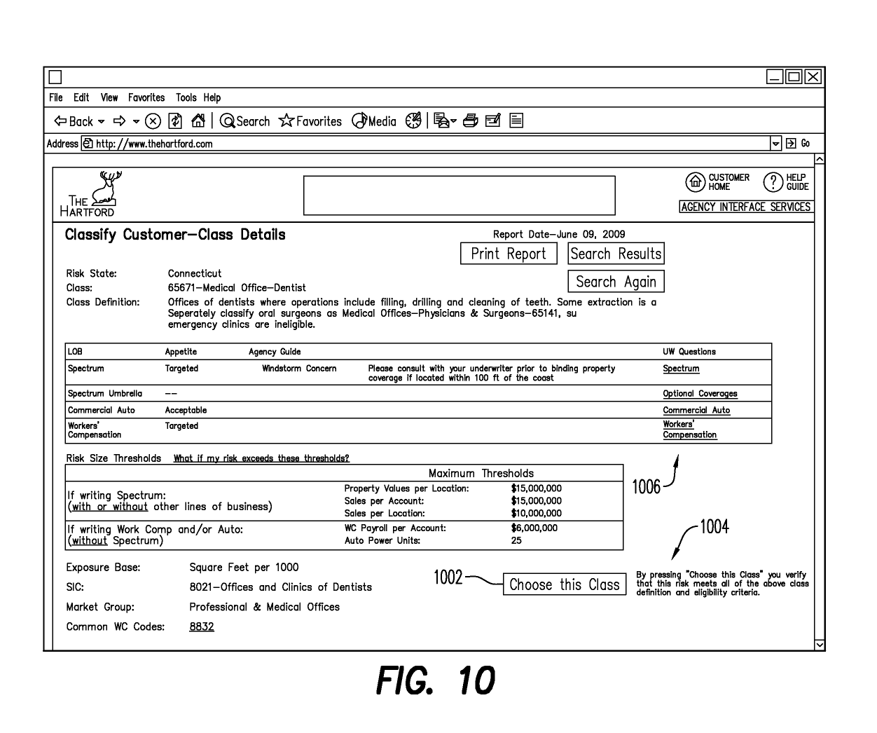

FIG. 10 is an example screen display that may be downloaded to the agent computer 118 from the new business computer system 204 and the agency front end application 402 in response to the agent/user selecting the customer classification from the FIG. 9 screen display. It will be noted that the screen display of FIG. 10 provides further information about the selected customer classification, including a formal definition of the classification and eligibility criteria established by the insurance company. With the button 1002 and accompanying statement 1004, the screen display asks the agent/user to verify that the proposed risk meets the definition and eligibility criteria. Before doing so, the agent/user may interact with a menu provided at 1006 to get information about the applicable underwriting questions for the type of insurance coverage that is to be obtained.

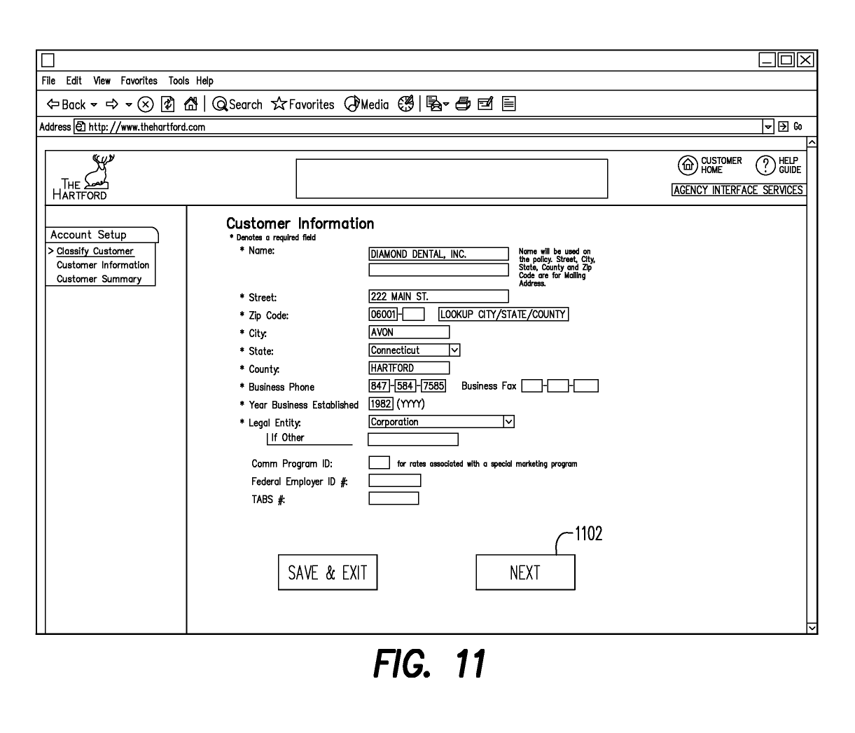

When the agent/user actuates the button 1002 in the FIG. 10 screen display, this completes the selection of the customer classification, as referred to in block 610 of FIG. 6. In response, the new business computer system 204 and the agency front end application 402 may download to the agent computer 118 a screen display like that shown in FIG. 11. The purpose of this screen display is to allow the agent/user to enter information about the customer, which activity is represented by block 612 in FIG. 6. The customer information to be entered may include the customer's name, contact information, etc. When the agent/user has completed entering this information, he/she may proceed to the next step by actuating the button shown at 1102 in the FIG. 11 screen display.

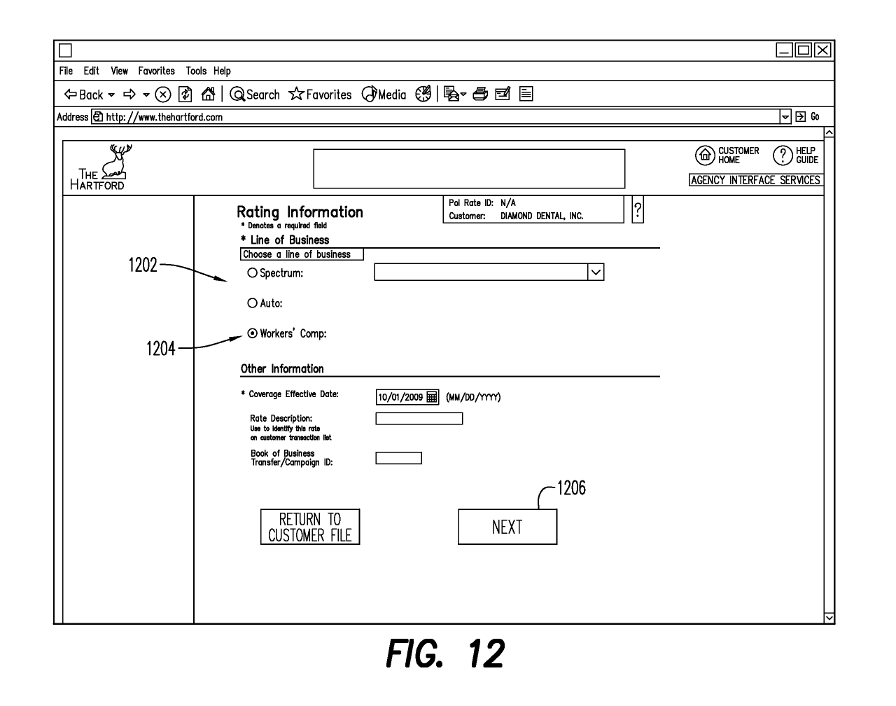

In response to actuation of the button 1102 in FIG. 11, the new business computer system 204 and the agency front end application 402 may download to the agent computer 118 a screen display like that shown in FIG. 12. The purpose of the FIG. 12 screen display is for entry of rating information (corresponding to block 614 in FIG. 6). At 1202, in the upper portion of the screen display, the agent/user is allowed to indicate what type of insurance coverage is being requested. For purposes of this example, it is assumed that workers' compensation coverage is being sought, as indicated at 1204. Other information may be entered in the lower portion of the screen display. The agent/user may actuate the “next” button 1206 to proceed to the next stage of the process.

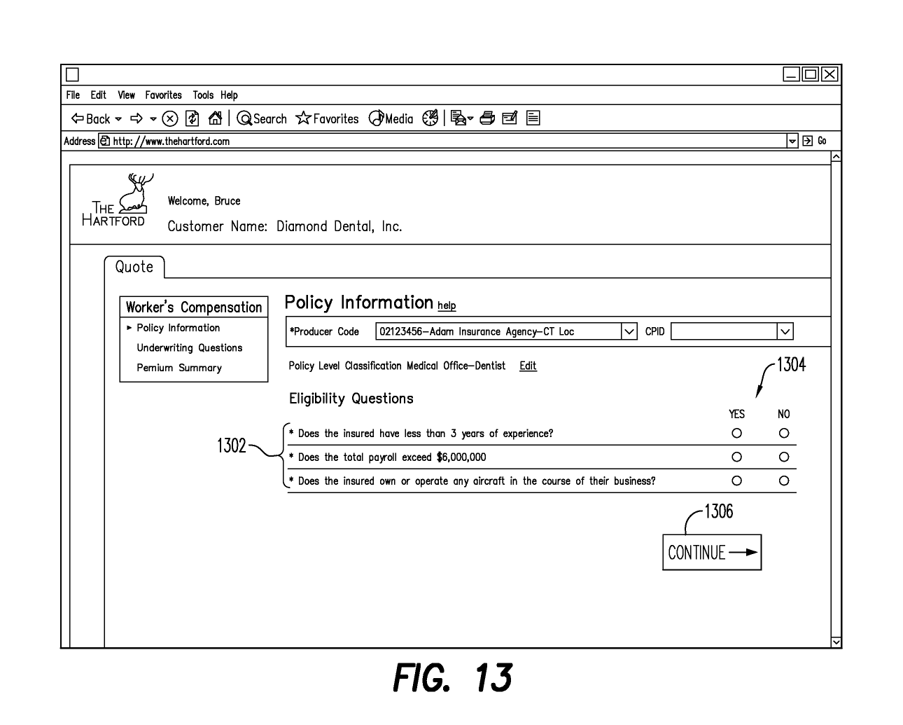

Actuation of the button 1206 in the FIG. 12 screen display may result in the new business computer system 204 and the agency front end application 402 downloading a screen display like FIG. 13 to the agent computer 118. The purpose of the FIG. 13 screen display is to allow the agent/user to respond to eligibility questions. This stage in the process is indicated by block 616 in FIG. 6. The eligibility questions are presented at 1302 in the FIG. 13 screen display. The eligibility questions may be provided by the underwriting questions service application 418 and may be reflexive in nature. That is, a response to a given eligibility question may cause one or more other eligibility questions to be presented to the user. After entering the responses at the “radio buttons” provided at 1304, the agent/user may actuate the “continue” button 1306.

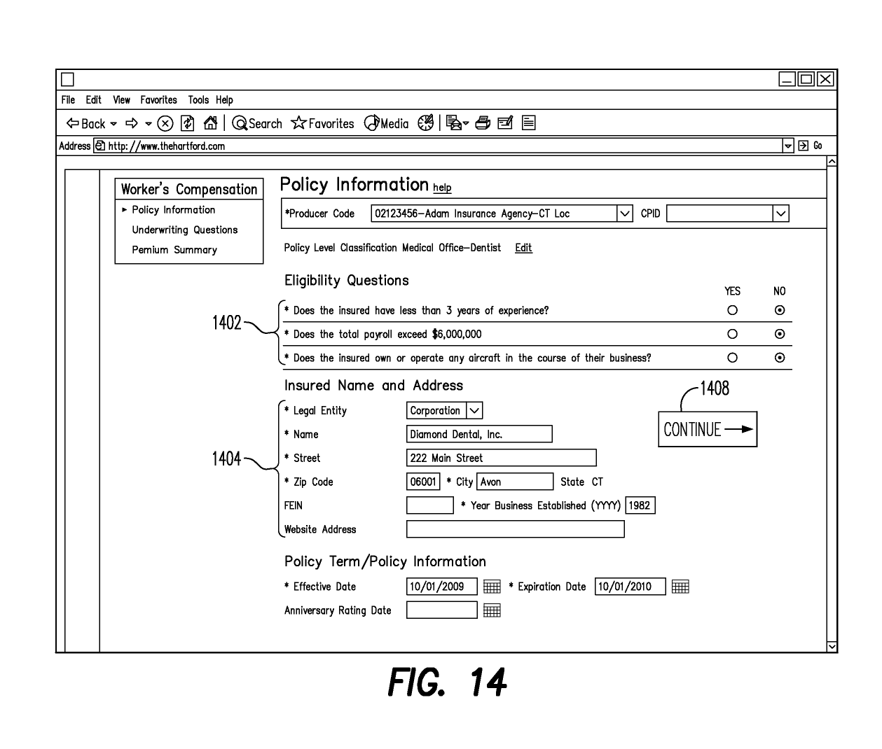

If the responses provided to one or more of the eligibility questions are not satisfactory, then the insurance company may decline the proposed coverage, and the new business computer system 204 and the agency front end application 402 may so indicate to the agent/user with a suitable screen display which is not shown. Alternatively, however, if the responses to the eligibility questions are satisfactory, then the new business computer system 204 and the agency front end application 402 may respond by downloading to the agent computer 118 a screen display like that shown in FIG. 14. The purpose of the FIG. 14 screen display is to allow the agent/user to enter policy information with respect to the requested insurance policy. Because this information may affect the amount of the premium that will be quoted, it too may be considered “rating information”. The entry and subsequent review by the agent/user of the policy information is indicated at 618 in FIG. 6.

At an upper part 1402 of the screen display of FIG. 14, the agent/user's responses to the eligibility questions are indicated. The insured's name and contact information are carried forward at 1404 from earlier screens. At 1406, the requested policy term is indicated.

In a portion of the screen display that is not visible in FIG. 14, the agent/user may be asked to select a type of billing procedure for the requested policy (e.g., direct to the insured or via the agent). In another portion of the screen display that is not visible in the drawing, the agent/user may be asked to indicate the requested policy limits (i.e., in this case, the employer liability limits). In still other portions of the screen display (not visible in the drawing), the agent/user may be asked to provide information about prior losses and/or the number of locations maintained by the prospective insured.

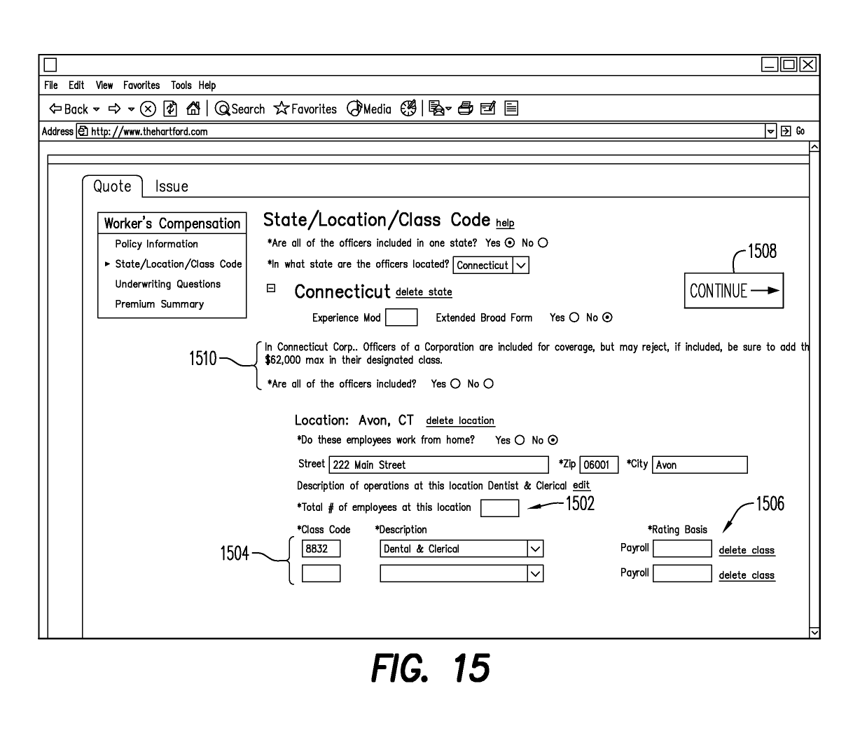

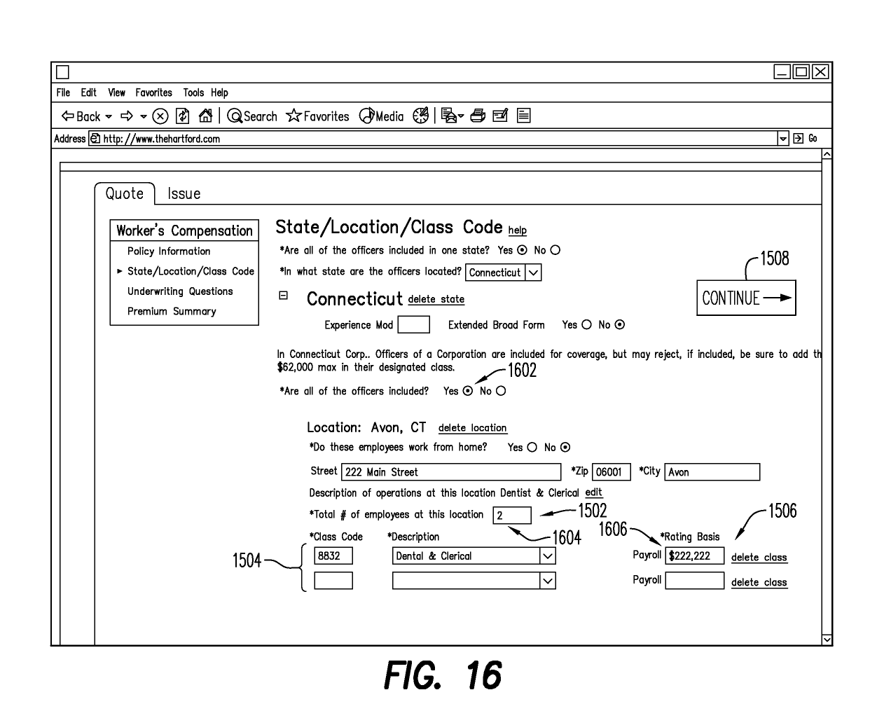

If the user/agent fills in and/or selects the requested information, and then actuates the “continue” button 1408, the new business computer system 204 and the agency front end application 402 may respond by downloading to the agent computer 118 a screen display like that shown in FIG. 15. The FIG. 15 display screen allows the agent/user to enter or confirm information relating to the location of the risk. Moreover, elements of the FIG. 15 screen display allow the agent/user to enter information that is an input for the rating process, and so is considered to be rating information. For example, at 1502 in FIG. 15 the agent/user may enter the number of employees for whom the requested workers' compensation coverage will apply. At 1504 in FIG. 15 the agent/user may indicate one or more classifications for the covered employees, e.g., from a drop-down menu as shown. At 1506, the agent/user is to fill in the amount of payroll for each class of covered employees. FIG. 16 shows the same display screen as FIG. 15, but with example rating information as it would be entered by the agent/user, as indicated at 1602, 1604, 1606.

FIG. 15 also illustrates an additional feature that may be provided by the new business computer system 204. This additional feature may be referred to as “coaching”. According to this feature, additional, context-relevant information is provided to the user to guide the user in interacting with the screen displays. In the particular example shown in FIG. 15, information provided at 1510 guides the user with respect to a particular coverage option available in the state where the proposed insured is located. The context-relevant information to be provided by the new business computer system 204 may vary according to, e.g., the state in which the risk is located, the type of coverage sought, and/or one or more attributes of the proposed insured, such as a classification category that applies to the proposed insured.

Once the agent/user has completed entry of the rating information requested in the screen display of FIGS. 15/16, he/she may actuate the “continue” button (indicated at 1508 in both FIGS. 15 and 16). This completes entry of the rating information, and in response, the new business computer system 204 and the agency front end application 402 may download to the agent computer 118 a screen display like that shown in FIG. 17. The purpose of the FIG. 17 screen display is to present underwriting questions to the agent/user. An example list of underwriting questions is shown in the drawing at 1702. It will be appreciated that the applicable underwriting questions may have been provided to the agency front end application 402 by the underwriting questions service application 418 that was discussed above in connection with FIG. 4. The underwriting questions may be reflexive in nature, in that a response to a given underwriting question may cause one or more other questions to be presented to the user. In one embodiment, the reflexive questioning function of the underwriting questions service application 418 may not be based on a hierarchical tree of questions, but rather may be assertion based. Each question may have an associated rule that determines (a) when it will be displayed and (b) whether it will generate a hard or soft stop in the process.

Continuing to refer to FIG. 4, the agent/user may respond to the underwriting questions by filling in data fields or by selecting the “yes” or “no” radio buttons, as called for by each underwriting question. The process stage of responding to the underwriting questions is indicated at 620 in FIG. 6. To register his/her responses to the underwriting questions, the agent/user may actuate the “continue” button provided at 1704 in the FIG. 17 screen display.

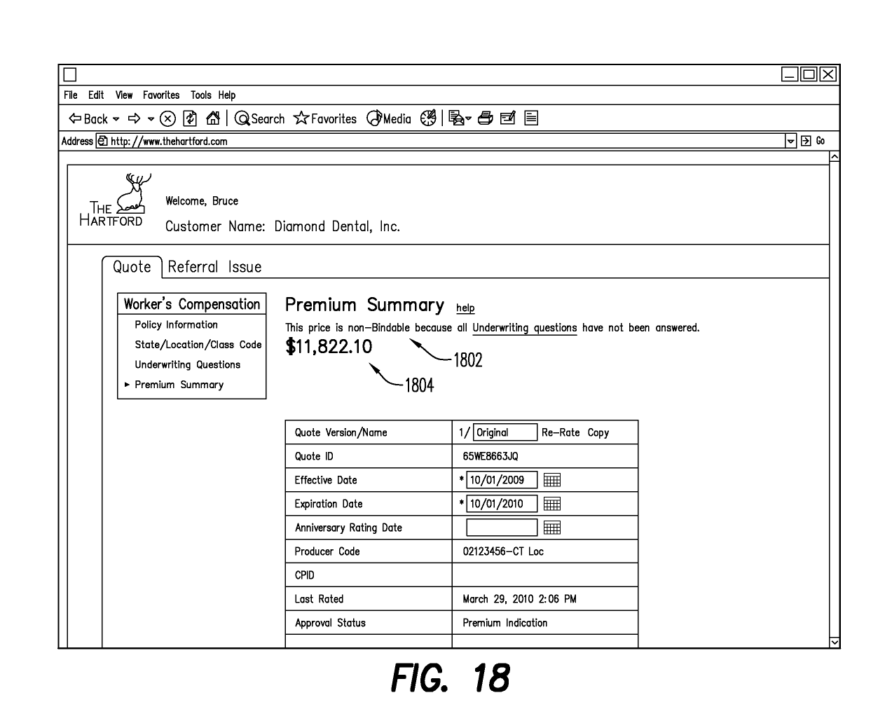

FIG. 18 is one example of a screen display that the new business computer system 204 and the agency front end application 402 may download to the agent computer 118 in response to actuation by the agent/user of the “continue” button 1704 on the underwriting questions screen display (FIG. 17). For the FIG. 18 example screen display, it is assumed that the agent/user did not answer all of the underwriting questions, and that the resulting premium quotation is “non-bindable”, as indicated at 1802 in FIG. 18. As is understood by those who are skilled in the art, “non-bindable” means that the quotation is not available for acceptance by the agent/user, but rather is subject to satisfactory completion of the responses to the underwriting questions. (It should be noted that a premium quotation may be non-bindable for reasons other than incompleteness of responses to underwriting questions. For example, a premium quotation may be non-bindable because it has been determined that referral to a human underwriter is required.) The amount of the quotation is indicated at 1804 in the FIG. 18 screen display.

The issuance of the quotation is indicated at 622 in FIG. 6. The determination that the premium quotation is to be non-bindable may be made by the orchestrations software 404 (FIG. 4) by applying suitable rules stored in the rules data storage facility 408. The amount of the quotation may be calculated by the rating/admin/issuance application 412 with reference to a risk score provided by the pricing module 414.

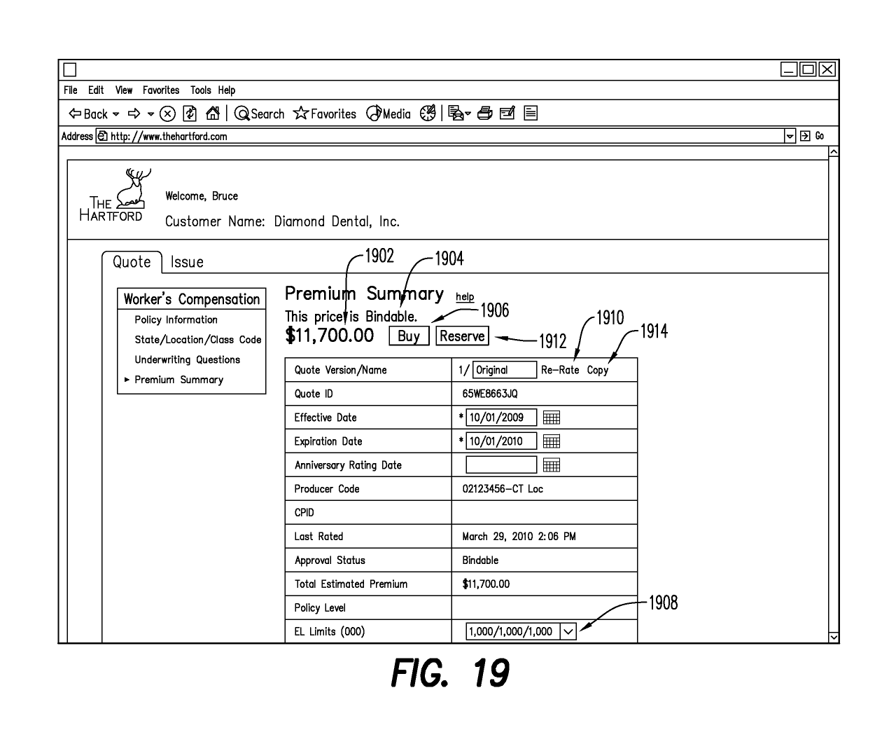

FIG. 19 is another example of a screen display that the new business computer system 204 and the agency front end application 402 may download to the agent computer 118 in response to actuation by the agent/user of the “continue” button 1704 on the underwriting questions screen display (FIG. 17). For the FIG. 19 example screen display, it is assumed that the agent/user satisfactorily answered all of the underwriting questions and that no referral to a human underwriter is needed. Consequently, the premium quotation indicated at 1902 is “bindable” (reference numeral 1904). This means that the agent/user is permitted to accept the quotation and obtain the desired insurance coverage by actuating the “buy” button indicated at 1906 in the FIG. 19 screen display.

Aspects of the requested coverage and/or of the risk to be covered may also be indicated in the FIG. 19 screen display. For example, at the drop-down menu 1908, the requested policy limits (employer liability limits) may be indicated. As another example (not shown), the amount of total payroll for the covered employees may be indicated.

The determination as to bindability may be made by the orchestrations software 404 (FIG. 4) by applying suitable rules stored in the rules data storage facility 408. The amount of the quotation may be calculated by the rating/admin/issuance application 412 with reference to a risk score provided by the pricing module 414.

The agent/user may invoke a re-rating function by changing the requested coverage (e.g., by interacting with the drop-down menu 1908) and then selecting the “re-rate” option provided at 1910 in the FIG. 19 screen display.

As an alternative to actuating the “buy” button 1906, the agent/user may actuate the “reserve” button indicated at 1912 in FIG. 19. This invokes the “reserve” function. According to the reserve function, the new business computer system 204 will not issue a quotation to another agent for the same prospective insured entity for a period of time, say, 60 days, and the quotation may be put on hold and kept available for acceptance by the agent/user until the reserve period has expired.

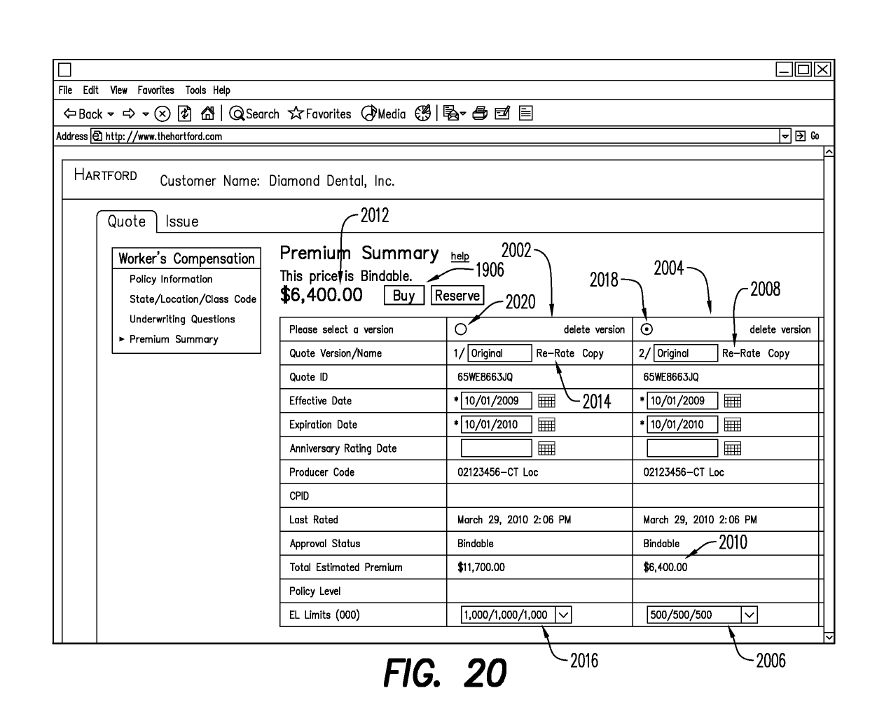

Another function that is accessible by the agent/user via the FIG. 19 screen display is a “copy” function, to be invoked by actuation of the “copy” option provided at 1914 in FIG. 19. In response to actuation of the “copy” option, the new business computer system 204 and the agency front end application 402 may download to the agent computer 118 a screen display in the format shown in FIG. 20. A salient feature of the format of the FIG. 20 screen display is that there are two quotation sections included therein, namely an original quotation section 2002 and a second (or copy) quotation section 2004. It will be noted that the quotation sections 2002 and 2004 are positioned side-by-side relative to each other in the FIG. 20 screen display. In the example depicted in FIG. 20, it is assumed that the agent/user has interacted with the drop-down menu 2006 in the second quotation section 2004 to indicate a different (lower) set of policy limits for the requested policy, and then the agent/user has actuated the re-rate option 2008 in the second quotation section 2004 to obtain an alternative quotation at the lower policy limits. It is also assumed that the rating function of the new business computer system 204, as embodied in the rating/admin/issuance application 412 and the pricing module 414, responded to actuation of the re-rate option 2008 of the second quotation section 2004 by generating an alternative quotation, presented in the FIG. 20 screen display at 2010 (in the second quotation section 2004) and also, more prominently, at 2012.

The re-rate option 2008 may include an actuatable portion of the screen display and is provided to allow the user to obtain an alternative or updated quotation to reflect a change in the rating information as input by the user. An advantage of the re-rate option is that the user only needs to enter or update the portion of the rating information that is changed, and does not have to re-enter the entire set of rating information. The re-rate option may also be available when only one quotation section is presented in the screen display.

(Of course, both premium quotations relate to the same proposed insured and the same risk, namely the insured who was identified by the agent/user at step 612 in FIG. 6. Also both premium quotations were issued by the same insurance company, namely the insurance company that operates the new business computer system 204, and are for the same kind of insurance—in this example for workers' compensation insurance.)

It will be noted that the original quotation section 2002 also includes its own re-rate option 2014. Thus the agent/user is permitted to interact with the policy limits drop-down menu 2016 in the original quotation section 2002 to select still another set of policy limits, and then to click the re-rate option 2014 of the original quotation section 2002 to have a different and new quotation generated for and displayed in the original quotation section 2002.

In the view provided in FIG. 20, only one type of rating information input element is shown—i.e., a policy limits drop-down menu in each quotation section, as indicated at 2006 and 2016. However, other types of rating information input elements may also be provided in the quotation sections 2002 and 2004, including for example fields that indicate the number of covered employees or the amount of total payroll.

It will also be noted that each quotation section also has a “select” option (indicated by reference numeral 2018 for the second quotation section 2004 and by reference numeral 2020 for the original quotation section 2002). In this example the “select” option 2018 for the second quotation section 2004 has been actuated, and as a result (a) the premium quotation for the second quotation section 2004 is presented prominently at 2012, and (b) if the agent/user were to actuate the “buy” button (FIG. 20), this would signify acceptance of the premium quotation and other policy attributes as presented in the second quotation section 2004. However, if the agent/user were to actuate the “select” option 2020 for the original quotation section 2002, this would select the original quotation section 2002 and the premium quotation and policy parameters presented therein, and would de-select the second quotation section 2004. With the original quotation section 2002 selected, the premium quotation therefor would be prominently displayed (contrary to what is seen in FIG. 20), and the premium quotation and other policy parameters presented in the original quotation section 2002 would form the basis for the insurance policy upon the agent/user actuating the “buy” button 1906 (FIG. 20).

A respective set of rating information, maintained by the new business computer system 204, supports each of the quotation sections. That is, if there are two quotation sections, as shown in FIG. 20, then the new business computer system 204 may maintain two sets of rating information for the proposed insureds—one for each quotation section. Initially, the new business computer system 204 may generate the second set of rating information by duplicating the first set of rating information. Thereafter, the user may interact with the second quotation section to modify the second set of rating information in order to obtain an alternative quotation.

The two quotation sections 2002 and 2004 are shown as being horizontally adjacent to each other in the example provided in FIG. 20. Alternatively, however, the two quotation sections may be vertically adjacent to each other, and for purposes of this discussion and the appended claims, the latter arrangement should also be deemed “side-by-side”. Moreover the term “side-by-side” should also be deemed to apply to any two quotation sections that are displayed simultaneously within the same screen display, regardless of how the quotation sections may be positioned relative to each other, and regardless of whether the quotation sections are separated from each other by any intervening space or display features.

In some embodiments, more than two quotation sections may be shown simultaneously in a single screen display. According to aspects of the present invention, any number of quotation sections may be shown simultaneously in a single screen display. With some formats and display screen dimensions, it may be desirable to present no more than four quotation sections simultaneously in a single screen display.

The process as reflected in FIGS. 19 and 20 is also illustrated in FIG. 6. Decision block 624 in FIG. 6 represents branching in the process flow, depending on whether the agent/user operates the interface provided by the agency front end application 402 to request alternative side-by-side premium quotations as described above with reference to FIGS. 19 and 20. If so, the above-described second quotation section 2004 is provided (block 626, FIG. 6) and the agent/user enters/selects alternative rating information (e.g., alternative policy limits) as also described above. Upon the agent/user's actuation of the re-rate option for the second quotation section 2004, the alternative premium quotation is generated and the two premium quotations are displayed side-by-side (block 628) as seen from FIG. 20.

Continuing to refer to FIG. 6, a decision block 630 follows block 628 or directly follows decision block 624, as the case may be. At decision block 630, the new business computer system 204 determines whether the quotation (or one of the alternative quotations, if requested) is accepted by the agent/user. For example, the agent/user may indicate acceptance of a quotation by actuating the “buy” button 1906 (FIG. 19 or 20). If this occurs, then block 632 follows block 630. At block 632 the new business computer system 204 issues an insurance policy in favor of the customer based on the quotation that was accepted and the policy attributes upon which the quotation was based. For example, policy issuance may be handled by the rating/admin/issuance application 412 (FIG. 4) after receiving (via the orchestrations software 404) an indication from the agency front end application 402 that the agent/user has accepted the quotation. In some embodiments, issuance of the insurance policy may include printing and mailing the insurance policy papers to the insured and/or to the agent. In addition or alternatively, the insurance policy papers may be electronically transmitted to the insured or the agent.

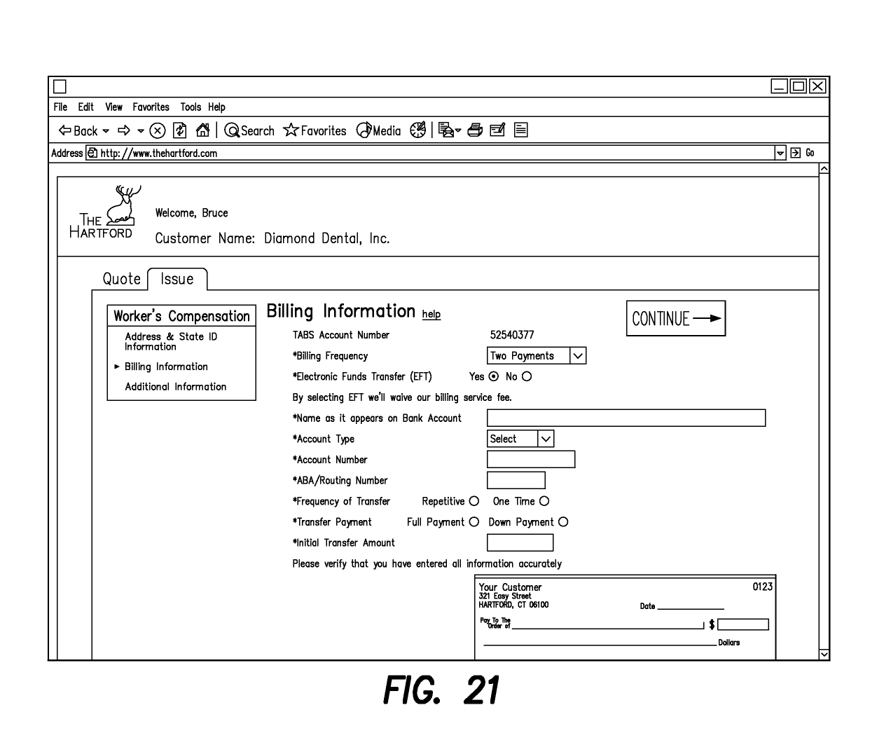

In aid of the issuance step, the agency front end application 402 and the new business computer system 204 may download to the agent computer 118 a screen display like FIG. 21. With this screen display, the agent/user may enter billing information to be utilized by the insurance company in managing billing of premiums to the customer.

Until the agent/user indicates acceptance of a quotation, the process of FIG. 6 may idle at decision block 630, as indicated by branch 634 from decision block 630.

In the screen display shown in FIG. 20, two separate quotation sections are present and two alternative premium quotations are shown. Alternatively, however, screen displays may be provided by the agency front end application 402 and the new business computer system 204 with three or four or more separate quotation sections and alternative premium quotations displayed simultaneously and/or in the same scrollable screen display.

The screen displays appended hereto are exemplary of the types of screen displays that may be provided in various embodiments and/or under various scenarios. Many other screen displays may also be presented by the system. It will be appreciated, for example, that some prospective insureds or proposed risks may not meet the insurance company's underwriting standards, in which case a suitable screen display (not shown) may be provided by the agency front end application 402 to indicate that the insurance company is declining to provide a quotation. Various error messages, etc., may also be provided in certain situations.

Still further, the request as presented by the agent/user may be such as to require referral, under applicable rules, to a human underwriter. Again, a screen display (not shown) to inform the agent/user to this effect may be provided by the agency front end application 402.

According to another option that may be presented by the agency front end application 402 to the agent/user (though not illustrated in the drawings), even when the premium quotation is bindable, the agent/user may be permitted to refer the request to a human underwriter, say, because the agent/user has a question about the proposed insurance coverage.

In the specific examples illustrated by the drawings, the requested insurance policy was for workers' compensation coverage. However, the principles of the present invention are applicable to any and all types of insurance, including both personal and business lines. For example, the screen displays and other aspects of the invention as heretofore described may be readily adapted to commercial or personal motor vehicle insurance policies. To give just one example, alternative quotations could be requested, in similar fashion to the screen display of FIG. 20, based on two or more different per occurrence deductible amounts to be applicable to requested motor vehicle insurance coverage. The principles of the present invention are also applicable to business owners insurance.

It has also been assumed for purposes of the accompanying drawings and discussion that the website and user interface to be offered via the insurance company's computer may be dedicated to use by independent agents. However, instead or in addition, the website and user interface may be configured to support usage by customer service representatives directly employed by the insurer, and/or by the prospective insureds themselves. Agents who use the agency front end application 402 may be proprietary and/or non-proprietary agents relative to the insurance company that provides the agency front end application 402.

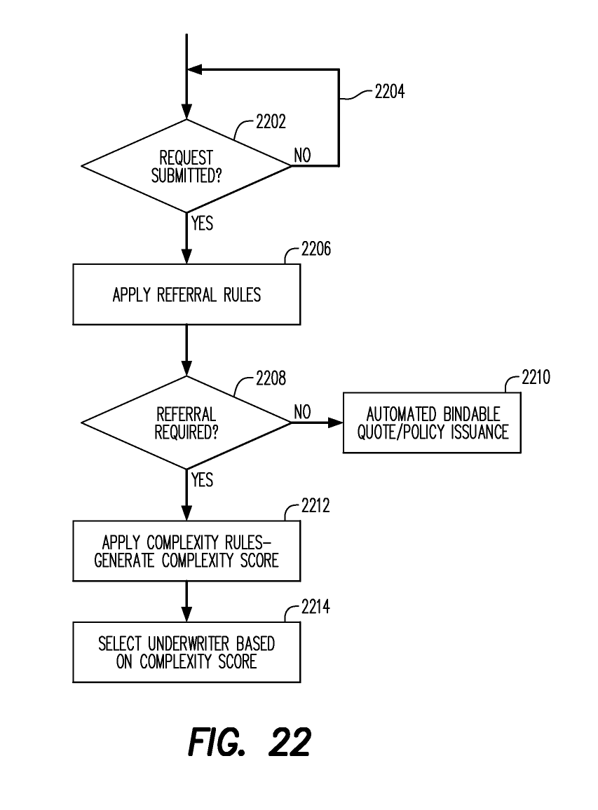

FIG. 22 is a flow chart that illustrates additional aspects of the process depicted in FIG. 6. More specifically, the process flow indicated in FIG. 6 proceeds on the assumption that a bindable quotation is automatically generated by the new business computer system 204, culminating in automatic issuance of the requested insurance policy. On the other hand, FIG. 22 illustrates a process flow that includes a branch for referral to a human underwriter.

At decision block 2202 in FIG. 22, the new business computer system 204 determines whether the agent/user has completed submission of a request for an insurance policy. Until this occurs, the process of FIG. 22 may idle at decision block 2202, as indicated by branch 2204 from decision block 2202. Once submission of the request is complete, the process advances from decision block 2202 to block 2206. At 2206, the new business computer system 204 (or an associated separate computer) may apply stored business rules to determine whether the request requires referral to a human underwriter. Decision block 2208 indicates the branching in the process based on this determination. If referral is not required, then the process of FIG. 22 advances from decision block 2208 to block 2210. Block 2210 encompasses automated generation of a bindable premium quotation and ultimately (if the agent/user so elects) policy issuance, as described above in connection with FIG. 6.

However, if referral to a human underwriter is required, the process advances from decision block 2208 to block 2212. At block 2212, the new business computer system 204 (or an associated separate computer) applies another set of business rules to generate a complexity score for the pending request for insurance. The complexity score may be a measure of how much the request for insurance, the characteristics of the risk, etc., depart from standard or straightforward requests for quotation. For example, the complexity score may be generated so as to increase with the number of locations and/or the number of employees for the prospective insured. In some embodiments, the set of data required to generate the complexity score may be submitted by the agent/user with, and overlap with, the set of data required for the automated decision on whether referral is necessary.

In some embodiments, the complexity score may be calculated as a weighted average of scores assigned based on various factors. The factors, may, for example, include the total premium, the industry category for the proposed insured, the frequency of losses for the proposed insured, and the severity of losses for the proposed insured.

The process of FIG. 22 advances from block 2212 to block 2214. It will be appreciated that the insurance company that operates the new business computer system 204 may employ a considerable number of individuals who are responsible for considering requests for insurance and making underwriting decisions. Moreover, there may be significant variations in the amount of experience that the underwriting employees have. At block 2214, the new business computer system 204 (or an associated separate computer) may use the complexity score generated at 2212 as an input to a process by which the computer determines to which underwriting employee the referral is to be sent. For example, requests with relatively low complexity scores may be referred to junior underwriting employees, while requests with relatively high complexity scores may be referred to more senior underwriting employees. To make this same point more explicitly, one request to which a relatively low complexity score is attached may be referred to a junior underwriting employee, and a different request with a higher complexity score may be referred to a different, more senior underwriting employee.

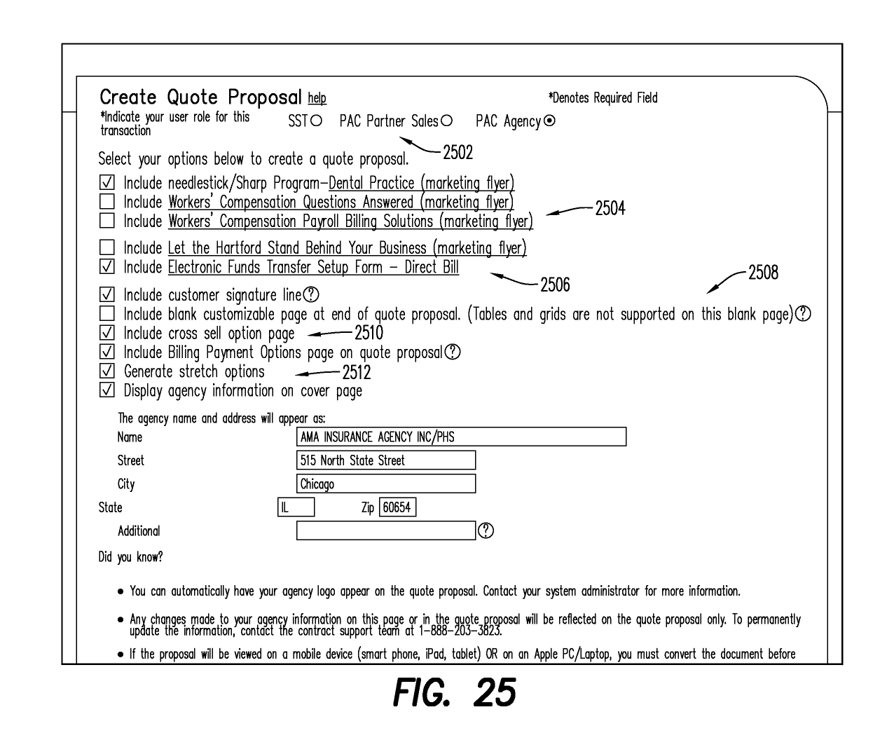

In some situations, a prospective insured may not wish to immediately bind an offer of insurance. Instead, the prospective insured may wish to receive and evaluate an offer. Commonly, agents manually create such proposals by printing, copying, and cutting and pasting information from various sources. Not only is this a time-consuming process, but it can lead to the creation of incomplete or inaccurate proposals. Pursuant to some embodiments, complex proposals may easily be generated using features of the present invention. In some embodiments, proposals pursuant to the present invention may be generated by a user of a client device (such as an insurance agent) after one or more quotations for insurance policies have been generated on behalf of a prospective insured (as described above). Proposals may be generated to include one or more quotations (e.g., if multiple insurance premium quotations were generated based on different rating information as described above, each or all of those quotations may be assembled into a proposal for transmission to the prospective insured). Features of some embodiments of a proposal generation process will now be described by reference to the process diagrams of FIGS. 23-24 and the sample user interfaces of FIGS. 25-32.

The user interface 2500 may be displayed to an operator of a computer (such as the agent computer 118 of FIG. 1) after a quotation has been generated for a prospective insured. For example, the user interface 2500 may be presented to an agent after the agent has completed working up a quotation (such as after the user interface of FIG. 20 is complete) and when informed by the insured that the insured would like to receive a proposal detailing the terms of the quotation. The user interface 2500 is for illustrative purposes only, and other fields or presentation of information may be used. As shown in FIG. 25, the user interface includes a number of types of information used by an agent to select information to be included in the generation of a proposal for the prospective insured. Pursuant to some embodiments, the user interface is rendered based on the application of one or more proposal rules (e.g., from database 218 of FIG. 2) which cause the user interface to appear with certain items of information pre-filled or pre-selected. Further, in some embodiments, the application of the proposal rules, in combination with data associated with the quotation, with the agent, and/or with the prospective insured, may cause the user interface to render differently (e.g., as a simple illustrative example, the user interface for a worker's compensation policy proposal may render differently than a user interface for a general commercial lines insurance policy proposal).

As shown in FIG. 25, an agent may be presented with a number of choices and options, some of which are pre-selected when the agent visits the page to generate a proposal (e.g., based on information associated with the policy quotation, the prospective insured, the agent, or the type of product for which the proposal is being generated). For example, in a section shown as 2502, a status or user role of the agent generating the proposal is shown (e.g., based on information from a single sign in, an access control list, or the like). The user role or status may allow (or prevent) certain actions from being taken or choices from being made.

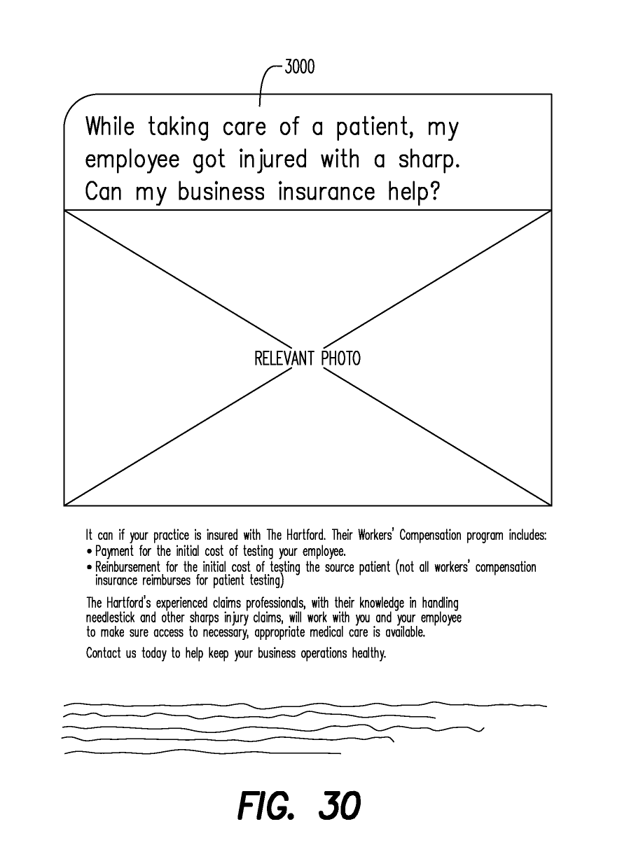

A section shown as 2504 may present the agent with one or more choices (four are shown as an example) of marketing materials that may be appropriate for inclusion in the proposal being generated. The selection of marketing materials presented in section 2504 may be determined under control of one or more proposal rules which define which marketing materials may be relevant for the product being quoted. The agent may then select or deselect from among the available materials, and the materials that are selected will be included in the generated proposal (as will be described further below). An illustrative example of a marketing material 3000 that may be included in a proposal package is shown in FIG. 30.

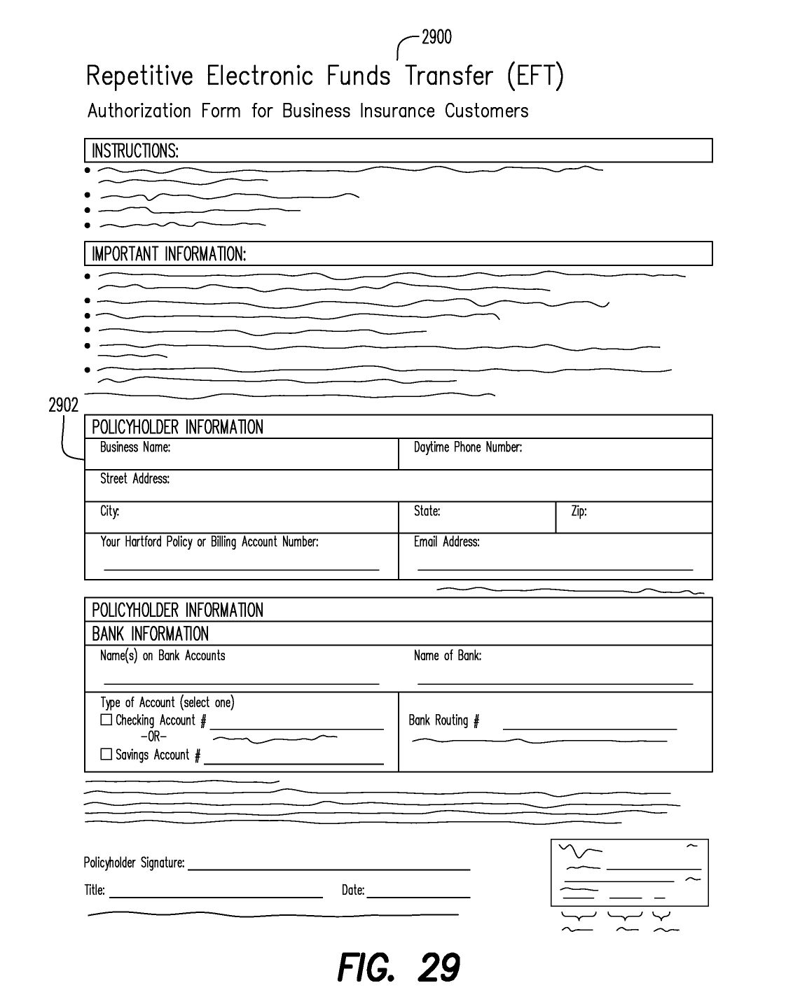

A section shown as 2506 may also be included which includes one or more options for forms to be included in the generated proposal. As depicted, a single form is available for inclusion in the proposal (a form for use in electronic funds transfers, an example of which is shown as FIG. 29, with areas that may be customized based on the current proposal shown in item 2902). A number of different types of forms may be included depending on the type of product, the agent, and the prospective insured. Pursuant to some embodiments, selection of a form for inclusion in the proposal may cause one or more fields of the form to be pre-populated or filled using information from the quotation, from a record of data associated with the prospective insured, and/or from a record of data associated with the agent.

A number of options may be presented to customize aspects of the proposal. For example items shown as 2508 may be provided to allow the agent to select customization options such as whether a signature page should be provided, and whether one or more blank customizable sheets be included in the generated proposal which may be used for other purposes. Further, the agent may select to customize the display of agency information on the front page of the proposal as well as to display the agency's name and address. Pursuant to some embodiments, some data, such as the agency name and address, may be retrieved from data associated with the agent and/or the quotation, reducing the chance of error as well as reducing the effort required to produce the proposal. For example, in some embodiments, the data associated with the agent can be retrieved from a datastore such as a datastore accessible by the agency profile module 422 which stores information such as a “producer profile” associated with each agency using the system of the present invention. Data from the producer profile for the agent generating a quotation(s) and proposal(s) pursuant to the present invention may be retrieved and inserted into one or more section(s) of a proposal during a proposal generation process.

In some embodiments, the agent may be presented with one or more options to include one or more cross-sell pages of information in the proposal (illustrated as the section at 2510). The cross-sell pages of information may include details of one or more offers deemed compatible with the product for which the proposal is generated (and may be obtained, for example, based on the application of one or more proposal rules to the quotation data). The agent may select to include or exclude such offers from the proposal package.

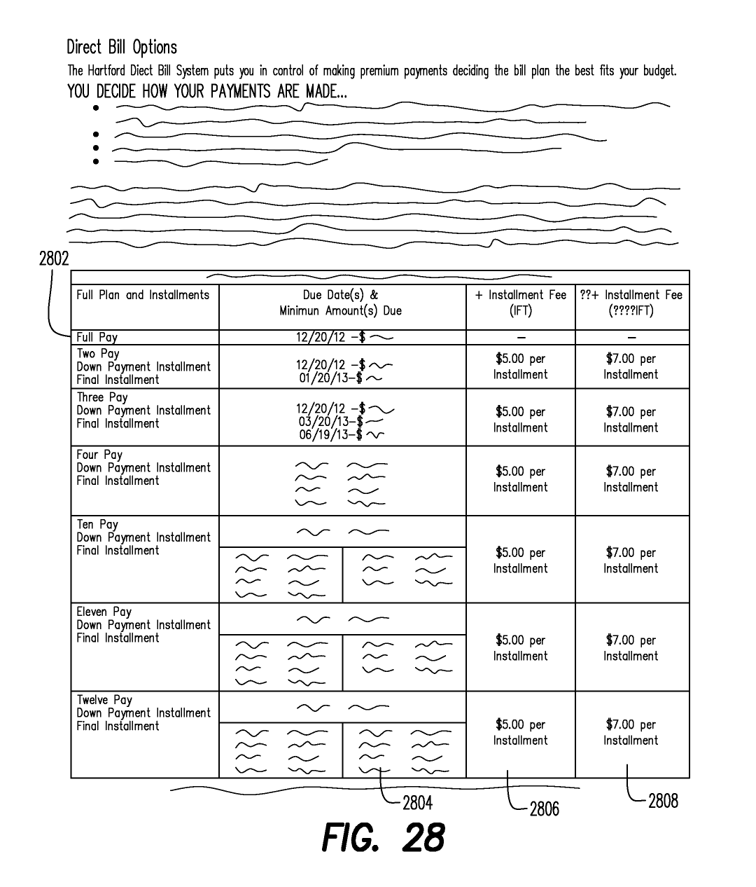

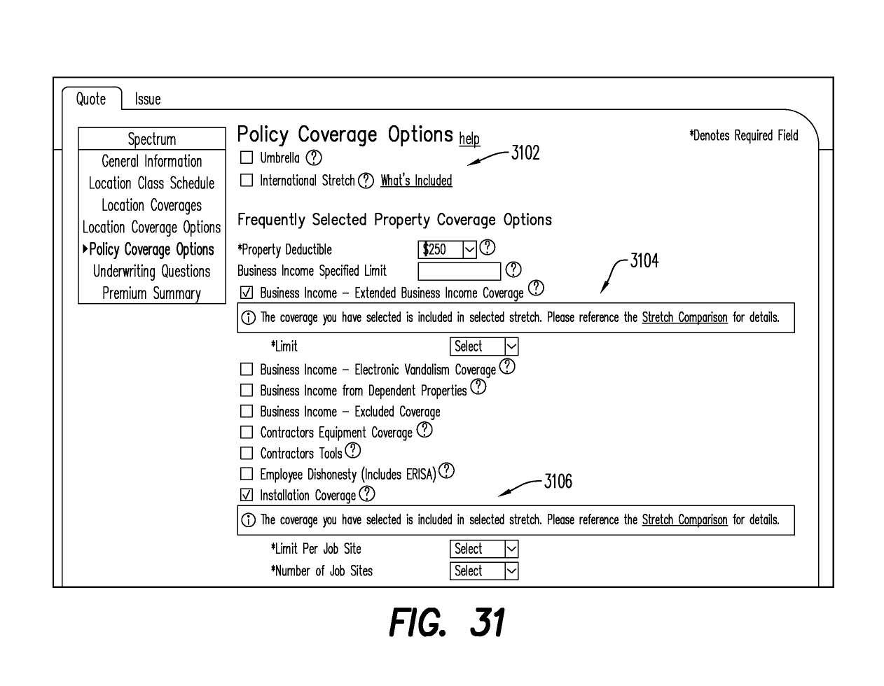

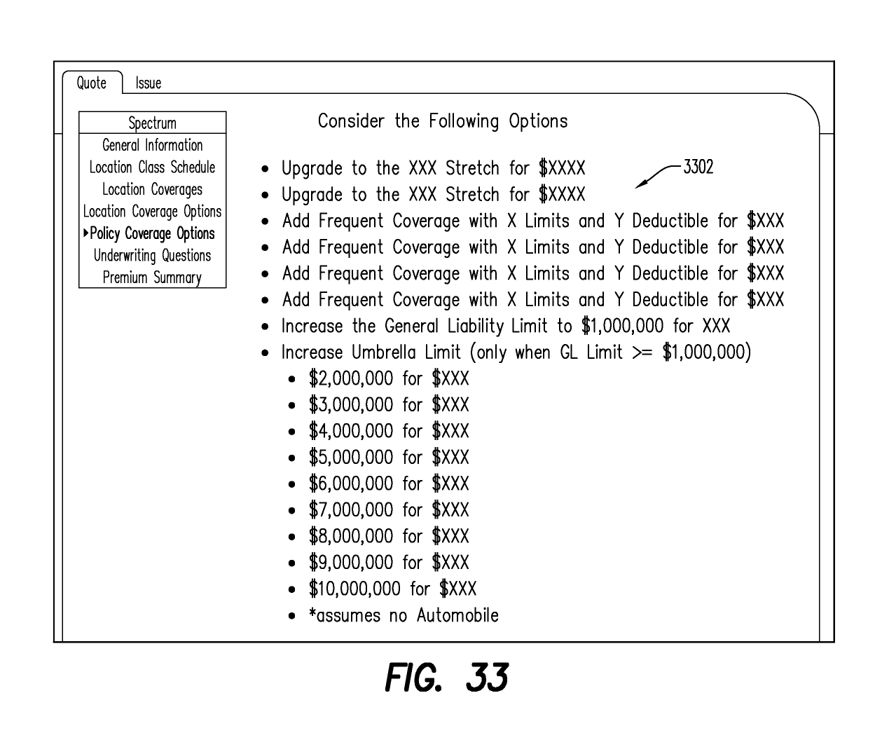

Pursuant to some embodiments, one or more pricing options may also be selected which allow specific types of pricing to automatically be generated and to produce one or more fee schedules for inclusion in the proposal. Such pricing options may displayed, for example, in a section shown as 2512 and may include, for example, a billing payment options page (such as shown in FIG. 28) in which a number of billing payment options are calculated and presented for use in the proposal. The billing payment options may be calculated based on a number of items of information such as, for example, the State, County, City in which the insured resides or conducts business (as tax and other fee information may change from jurisdiction to jurisdiction), the product type, terms of the quotation, or the like. As another example of pricing options that may be generated based on selection of the agent, one or more “stretch” or “expanded coverage” options may also be priced and included in the generated proposal. Further details of such additional coverages and their pricing will be described further below in conjunction with a discussion of FIGS. 31-33. In general, as used herein, the terms “expanded” or “stretch” coverage are used to refer to a bundle of additional coverages that may be added to or that may replace the underlying or base coverage selected as described above. Pursuant to some embodiments, the expanded coverages that are available for packaging or bundling with an underlying coverage may be selected using a process as described below in conjunction with FIG. 24A, and FIGS. 31-33. Pursuant to some embodiments, once one or more expanded or stretch coverages are identified, a proposal including those expanded coverages as well as the underlying coverage and associated materials may be generated pursuant to the present invention.

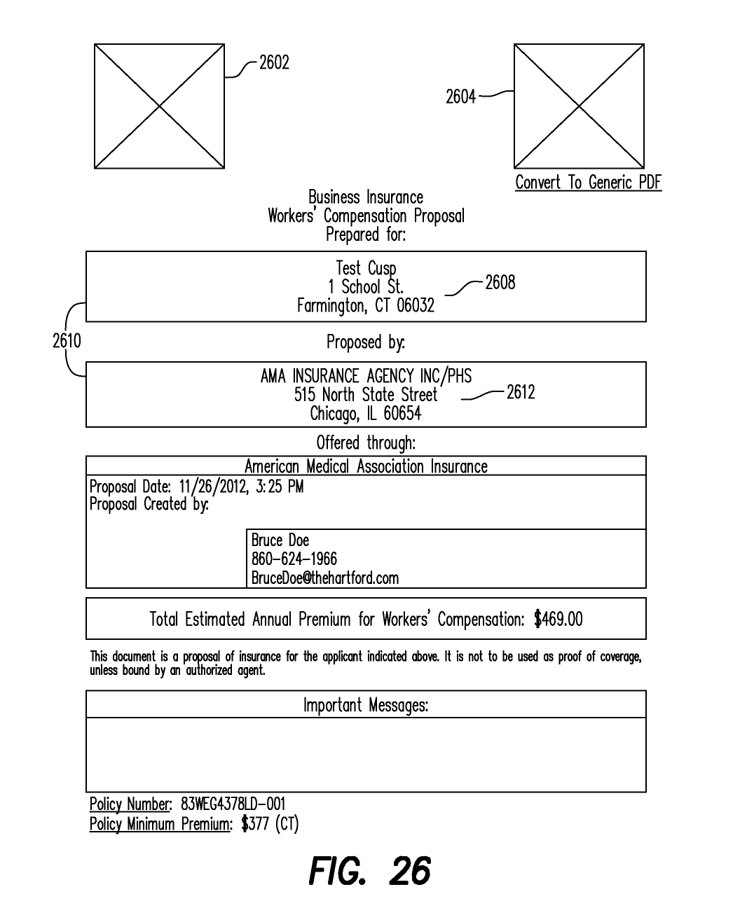

Once an agent has selected the desired components or sections of the proposal along with any customizations, the agent may submit the data to cause the creation of a proposal with those components or sections and customizations. An example cover page of such a proposal is shown in FIG. 26

Reference is now made to the process 2300 of FIG. 23 which may be performed under control of computer program code as described above in conjunction with FIG. 3, and the process may be performed after a quotation for one or more insurance policies is created (e.g., such as after the completion of the user interface of FIG. 20 and/or after obtaining a quotation at step 628 of FIG. 6). For example, an agent interacting with a prospective insured may determine that the prospective insured wishes to receive a detailed proposal describing the terms of the quotation prior to binding the insurance policy.

Process 2300 begins at 2302 where the agent selects an option to generate a proposal pursuant to the present invention. For example, an agent in the process of interacting with the system of the present invention to generate one or more quotations may determine that it is desirable to generate a proposal for delivery to the prospective insured.

Processing continues at 2304 where the system identifies the agent's user role and permissions. For example, this may be performed based on an access control list or other permissioning control data. At 2306, the system identifies a product type and related marketing document(s) that are associated with the quoted policy. For example, this may include querying a database of marketing data to identify one or more marketing documents that are relevant to the specific product type for which a quotation was obtained. As a simple illustrative example, the product type may be used as a query parameter to access data in a database including a plurality of marketing documents, each of which includes metadata identifying the type(s) of products that the marketing document is relevant to.

Processing continues at 2308 where a user interface (such as the user interface of FIG. 25, described above), is rendered based on the user role, permissions, and product type (as well as any other relevant data). For example, active scripting or other scripting (such as PHP, Javascript or the like) may be used to render an HTML page which includes the dynamic display of data based on the user role, permissions and product type. As shown in FIG. 25, such rendering may include pre-selecting certain options or check boxes, as well as displaying only relevant options (such as displaying only those marketing materials determined to be relevant for the product being quoted). A number of different scripting or rendering approaches may be used to ensure that only relevant data is displayed and available to an agent. For example, the user interface may be generated based on server-side data obtained or determined at steps 2302 and/or 2304 (as well as other data known about the particular agent, the insured, and the quotation).

Processing continues at 2310 where the system receives a selection of one or more proposal options (e.g., as shown in the illustrative user interface of FIG. 25). The proposal options may include marketing materials, pricing options, upsell options and other customizations as well as a presentation of the terms of the quotation generated as described above. The selections are transmitted to a system such as the proposal engine 216 for generation, assembly and creation of a proposal (step 2312) for delivery to the prospective insured.

In some embodiments, prior to generation of a proposal, one or more additional processes may be performed under control of the new business system of the present invention. For example, in some embodiments, a process such as that shown in FIG. 24A may be performed in which a user (such as an agent) may interact with the system to obtain one or more expanded coverage option(s) that are compatible with the underlying coverage. Once the expanded coverage option(s) are identified, processing may continue with a proposal generation process as shown and described in conjunction with FIG. 24B. In some embodiments, the expanded coverage option process may be an optional process, and the proposal generation process shown in FIG. 24B may be performed after completion of the quotation processing of FIG. 6 (e.g., in some embodiments, a proposal may be generated without identifying any expanded coverage options).

Further details of the processing associated with the determination and selection of appropriate extended coverage option(s) will now be described by reference to FIG. 24A in which a process 2400 is shown which may begin, for example, at the conclusion of step 630 of FIG. 6 (e.g., when a quotation has been generated and the agent determines that rather than issuing the policy, the prospective insured wishes to, or would potentially benefit from, receiving information about one or more extended coverage options compatible with the underlying policy quotation).

The process 2400 begins at 2402 where a determination is made whether expanded coverage processing should occur. For example, in some situations, an agent (or insured) may choose to not review any expanded coverage options. In such situations, processing proceeds at 2404 and no expanded coverage options are analyzed or identified, and processing continues as shown in FIG. 24B and a proposal is generated pursuant to embodiments of the present invention.

In other situations, processing continues at 2406 where a request to determine expanded coverage option(s) is generated. Pursuant to some embodiments, the request to determine expanded coverage options is generated as a web service request which includes information about the underlying policy (e.g., such as one or more of the policies which were quoted as described above). For example, a request to determine expanded coverage options may be generated which includes information associated with an underlying policy and information associated with the prospective insured. The request may include information identifying the location of the insured (or the insured activity or property), policy level information, as well as other information associated with the policy type and coverage.

Further details of the processing associated with the generation, assembly and creation of a proposal will now be described by reference to FIG. 24B in which a process 2420 is shown which may begin, for example, at the conclusion of step 630 of FIG. 6 (e.g., when a quotation has been generated and the agent determines that rather than issuing the policy, the prospective insured wishes to receive a proposal).

The process 2400 begins at 2402 where the proposal engine is operated (e.g., upon receiving data indicating that an agent interacting with the orchestrations software 404 has selected to initiate proposal generation). Processing at 2402 may begin with a plurality of items of data being made accessible to the proposal engine (e.g., such as data generated or available from the quoting process described above). This data may include data identifying the agent, data identifying the quotation, data identifying a product associated with the quotation, or the like. This data is used by the proposal engine to make certain determinations and to perform processing as shown in FIG. 24.

At 2402, the proposal engine determines whether any marketing materials are available and appropriate for inclusion in a proposal for the quotation. For example, the determination at 2402 may involve comparing data (or “attributes”) associated with the quotation to data associated with a plurality of marketing flyers or materials. Each of the marketing materials or flyers may have meta data associated therewith, for use in identifying which products, geographical areas, lines of business, or other criteria are required for including the marketing materials in a proposal. For example information from the quotation used to identify appropriate marketing materials may include: information associated with the product for which a quotation has been generated (for example, a product type, a coverage code or coverage type, a coverage class, etc.); information associated with the line of business of the prospective insured, information associated with the geographical location of the prospective insured, or the like. Each of these attributes of the quotation (or the prospective insured) are compared to data associated with the marketing materials to determine if one or more marketing materials are appropriate for inclusion in the proposal being generated. If materials are appropriate, a title of the marketing material is rendered and displayed on a user interface (such as the user interface 2500 of FIG. 25) for selection or deselection by the agent. If the agent selects one or more of the materials for inclusion, processing continues at 2404 where those materials are included in the generation of the package of relevant material(s) for the proposal.

Processing continues at 2406 where a determination is made whether one or more pricing options are to be executed. This processing may include several components, including an initial component that is performed prior to rendering a user interface for view by the agent. The initial component may involve a comparison of attributes of the quotation with stored pricing requirements to determine whether any pricing options are to be displayed for selection by the agent (e.g., such as the options shown in the user interface 2500 as items 2512). As one example, the initial determination may involve comparing attributes of the quotation with stretch coverage availability data to determine whether one or more stretch coverages are available for inclusion in the proposal for the particular insurance product for which a quotation has been generated. The identification of such stretch coverages may include a search of one or more data stores to determine if one or more stretch coverages are available for the specific coverage type, coverage area, and line of business for which a proposal is generated. Any relevant coverage types identified may be rendered as options in the user interface displayed to the agent (e.g., such as item 2512 of interface 2500).

Other pricing options that may be displayed to the agent may include an option to generate a detailed billing estimate for inclusion in the proposal (e.g., as shown in FIG. 28). If a billing estimate is available as an option for inclusion in the proposal, the user interface is rendered to include an option for the agent to select to include a billing estimate in the proposal. The agent then may select to include one or more of the pricing options (including, for example, the stretch coverages and the billing estimate) at 2406. The system then performs processing to calculate pricing and the fee or billing schedule based on the selected options at 2408. This processing may include complex queries and processing to generate pricing and schedules for inclusion in the proposal. For example, referring briefly to FIG. 28, if the agent selects to include a billing estimate, a billing estimate may be generated for inclusion in the proposal which includes a detailed breakdown of payment options for the product for which a quotation was generated. The detailed breakdown may include the application of one or more billing rules associated with the product. As shown in FIG. 28, the product is compatible with multiple payment plans (including a full pay 2802 as well as extended payment plans). Each payment plan has a breakdown of the payment due date and payment amount (shown as item 2804) as well as any ancillary fees associated with each payment plan 2806, 2808 including, for example, any taxes, surcharges or installment fees (which may vary from State to State and even within States). The calculation of each of these fees and dates may require application of one or more product-level, state-level or other rules to properly generate the correct fee amounts and dates.

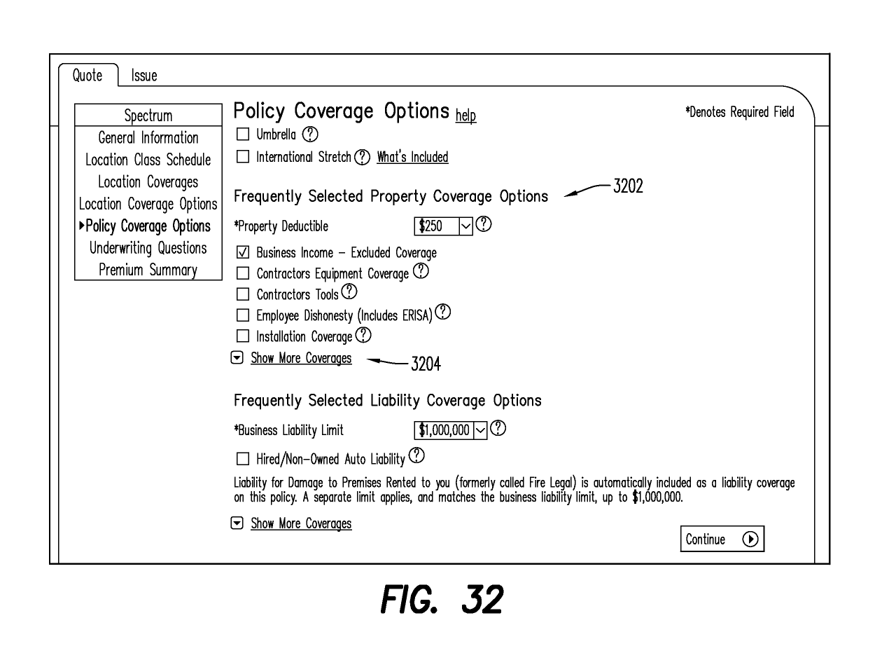

Processing may continue at 2410 where one or more stretch option(s) that have been selected by the agent (e.g., by interacting with the user interface 2500 or the interface 3100 of FIG. 31) are generated or priced. Details of such pricing will be provided further below in conjunction with FIGS. 31 and 32.

Processing continues at 2412 where the pricing and stretch option(s) are added to the proposal package being assembled.

Processing continues at 2414 where a determination is made whether one or more upsell or cross-sell option(s) are selected for inclusion in the proposal package. For example, processing at 2414 may include several components, including a component which is performed prior to rendering the user interface 2500 displayed to the agent. This component may include comparing features of the product or quotation to determine whether any relevant upsell or cross-sell offers are available for display to the agent via the user interface. This determination may include comparing attributes of the quotation with meta data associated with a plurality of cross sell or upsell offers to identify one or more available offers to present in the user interface. If one or more such offers are available, they are presented to the agent via the user interface 2500 (e.g., such as at item 2510). If the agent selects to include the offers in the proposal, processing continues at 2416 and the offers are assembled into the package. In some embodiments, the offers are personalized to the prospective insured, and may be tagged or coded with a unique offer identifier to track whether the prospective insured takes advantage of the offers.

Processing continues at 2418 where a determination is made whether any proposal customization options are available. Processing at 2418 may include several processing components, including a component that is performed prior to rendering a user interface for presentation to an agent, and a component that is performed by interaction between the agent and the user interface. For example, the user interface may be rendered to include one or more customization options based on attributes associated with the quotation. The customization options may then be presented as options to the agent via the user interface (e.g., such as items 2508 of FIG. 25). Processing continues at 2420 where the customizations are applied if the agent selects to take advantage of the one or more customization options. For example, an agent may customize the proposal by adding custom pages to the proposal (e.g., by editing a page using an inline editor, by adding logos or other creative, by adding personalized messages, by including optional pages, or the like). One example of a customization is shown in FIG. 26 where a cover sheet of a proposal is shown. In the example, two images or logos have been selected for inclusion on the proposal, 2602, 2604. An agent may select to add one or more logos for printing and inclusion on the proposal to further personalize the proposal and to increase brand awareness (e.g., by including a logo of the agent's agency, as well as a logo of the insurance provider).

Referring again to the process 2400 of FIG. 24, processing continues at 2422 where the agent interacts with the user interface to finalize the package design. Once the agent is satisfied with the various proposal options selected, the agent may generate the proposal. This causes an editable package to be rendered and presented to the agent for review and possible editing. The editable package may be rendered in a separate browser window viewable by the agent, such as the window shown in FIG. 26. Pursuant to some embodiments, the proposal engine may cause certain areas or sections of such a rendered proposal to be editable by the agent (based on the agent's permissions, role, and the proposal details). In the illustrative view of FIG. 26, several shaded areas are shown (including areas 2610). These shaded areas are editable by the agent by clicking on the area and entering updated or modified information into the section. Pursuant to some embodiments, only certain types of data are editable, such as, for example, data unrelated to pricing or the details of the quotation. Area 2608 includes an identification of the prospective insured, and area 2612 is the name and address of the agency issuing the proposal. These areas, and others, may be edited to provide a more personalized proposal for the prospective insured. The package presented to the user at 2424 may include a number of pages based on selections and processing performed from 2402 to 2418 such as, for example, a cover page, the details of the quotation, any selected marketing materials, any selected forms, any selected pricing options (such as a fee or billing statement, any stretch options and schedules), any selected upsell marketing materials, and any customizations.

Once the agent is satisfied with the design of the package, processing continues at 2426 where the agent causes the proposal package to be transmitted to the prospective insured. Processing at 2426 may include causing the package to be transmitted via email, via postal mail, via facsimile, or any other transmission process. Pursuant to some embodiments, the final proposal package is rendered as a PDF document (assembled using the document assembly component 434 of the system). The result is an ability for agents to easily, accurately, and efficiently generate and provide detailed proposal packages to prospective insureds.

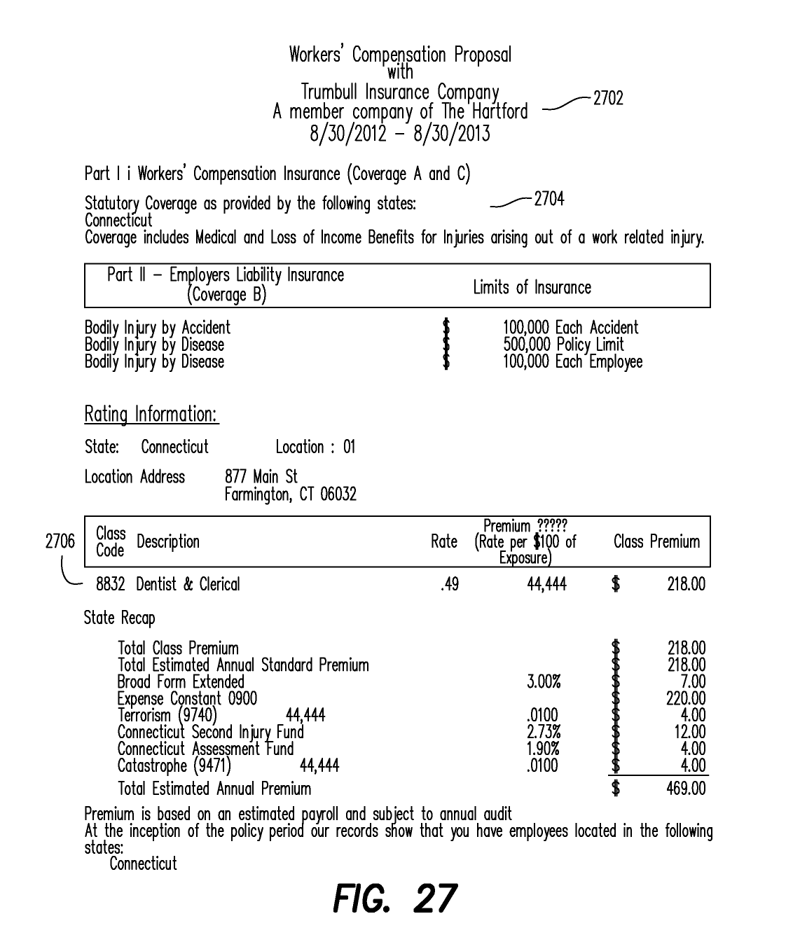

The generated proposal includes the accumulation of a wide variety of data usable by a prospective insured to evaluate a quotation. For example, referring to FIG. 27, a summary of the policy terms, limits and premium may be provided. The sheet shown in FIG. 27 includes a header 2702 personalized to show the agent issuing the proposal, a section 2704 showing the coverage and territory, and more detailed sections showing the coverage and limits as well as the class code 2706 and premium. Pursuant to some embodiments, a class code tool may be used by the agent in generating the quotation and proposal. The class code tool may allow the agent to more accurately identify the specific class code of the prospective insured. Pursuant to some embodiments, the class code tool allows an agent to perform searches based on a possible class description, an insurance code, a standard industry code (“SIC”), or other common classification codes. The tool then displays one or more options to the agent based on the provided information allowing the agent to select between among one or more potential class codes that the business may be classified under. Pursuant to some embodiments, the options may include a class description, the relevant class codes (including the SIC code) as well as information indicating whether the insurer is actively interested or available to underwrite policies in the class. Pursuant to some embodiments, the tool uses data from one or more credit bureau databases and other data sources to assist the agent in selecting the appropriate classification for a prospective insured. Those skilled in the art, upon reading this disclosure, will appreciate that the classification tool may be used by an agent earlier in the proposal and quotation process to ensure that the quotation and proposal is generated appropriately.

Pursuant to some embodiments, so-called “stretch” or ancillary coverages may also be quoted and included in proposals of the present invention. The underwriting and pricing rules for such ancillary coverages can be quite complex and are frequently difficult for agents to accurately quote and generate proposals. For example, many ancillary coverages or endorsements are not available to be issued with certain insurance products. Further, certain ancillary coverages or endorsements are more common than others. Applicants have discovered that a quoting process and proposal generation process of the present invention may be desirably used to more accurately select, price, quote and propose such ancillary coverages. For example, one desirable approach will now be described by reference to FIG. 31, where a user interface is shown which may be presented to a user operating a client device.

The user interface of FIG. 31 may be presented to a user during a quotation process (e.g., after a quotation for an underlying insurance product has been generated). In some embodiments, the user interface may be presented to a user during a proposal generation process (e.g., after an underlying quotation has been generated, and while the agent is generating a proposal, such as at step 2410 of FIG. 24). In some embodiments, the user interface of FIG. 31 is rendered based on the user role, permissions, and product type (as well as any other relevant data). For example, active scripting or other scripting (such as PHP, Javascript or the like) may be used to render an HTML page that includes the dynamic display of data based on the user role, permissions and product type. As shown in FIG. 31, such rendering may include pre-selecting certain options or check boxes, as well as displaying only relevant options (such as displaying only those marketing materials determined to be relevant for the product being quoted). A number of different scripting or rendering approaches may be used to ensure that only relevant data is displayed and available to an agent. For example, the user interface may be generated based on server-side data obtained or determined at steps 2302 and/or 2304 (as well as other data known about the particular agent, the insured, and the quotation on the underlying insurance product).

In the illustrative user interface of FIG. 31, one or more stretch options (or ancillary coverages) associated with an underlying insurance product are shown where the underlying insurance product is a small commercial insurance policy for an electrician. As shown the user interface is generated with several options preselected, as well as options that are relevant or appropriate for quoting in conjunction with a small commercial policy for an electrician, including a property deductible option, a field for entry of a business income limit, a stretch or ancillary option for a “Business Income—Extended Business Income Coverage”, and several other options which are relevant to electrical contractors and/or for small commercial policies. As shown, several of the stretch or ancillary coverages prompt the user that the coverage is a stretch coverage and that the user should consult a stretch comparison tool for details. Such prompts are dynamically generated when the page renders based on the input data associated with the underlying insurance product, the agent, and the agent's role. By rendering a page or user interface in such a manner, increased accuracy and relevance of stretch or ancillary coverages may be provided to agents, allowing better quotations and improved proposals for prospective insureds. Each of the stretch or ancillary coverages as well as limitations and options, are generated and rendered by a server such as the web server or agency front end 402, allowing an insurance company to enforce rules across a wide variety of different agents, thereby providing consistent, accurate and relevant stretch and ancillary coverage options are presented to prospective insureds.

Once the agent has selected the desired options, the selections are transmitted to the web server for further processing including the generation of pricing information. Reference is now made to FIG. 32 where an example user interface is shown which presents a number of pricing and coverage options to a user of a client device after completion of submission of the form of FIG. 31. As shown, a number of pricing and coverage options 3202 have been generated by the system of the present invention, including a wide variety of options which provide different limitations of liability for different prices. Each option is generated by the orchestrations module 404 in conjunction with pricing tables 414 based on the underlying insurance product, the stretch or ancillary options selected in FIG. 31, and details of the prospective insured. As shown, a wide variety of coverages and limitations may be priced, allowing an agent to select those that should be included in a proposal generated pursuant to the present invention.

Processes portrayed herein as being performed by one computer may in practice be divided among two or more computers. Processes portrayed herein as being performed by two or more computers may in practice be performed by a single computer.

The process descriptions and flow charts contained herein should not be considered to imply a fixed order for performing process steps. Rather, process steps may be performed in any order that is practicable.

As used herein and in the appended claims, the term “computer” refers to a single computer or to two or more computers in communication with each other and/or operated by a single organization or by two or more organizations that are partly or entirely under common ownership and/or control.

As used herein and in the appended claims, the term “processor” refers to one processor or two or more processors that are in communication with each other.

As used herein and in the appended claims, the term “memory” refers to one, two or more memory and/or data storage devices.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A computer system, comprising:
a web server component for hosting webpages and downloading the webpages to client computers in response to requests from the client computers, the web server component operated by or on behalf of an insurance company;
a rating engine component in communication with the web server component, for receiving input rating information from the web server component, said input rating information relevant to insurance coverage rating decisions, said input rating information received from one of the client computers via the web server component, the rating engine component including a processor programmed to apply rating rules to the input rating information to generate premium quotations for a proposed insurance policy for a prospective insured;
a rating rules database in communication with the rules engine component and including a data storage device that stores said rating rules applied by the processor; and
a rules engine component in communication with the web server component, for determining, in accordance with business rules, whether to provide bindable insurance coverage premium quotations in response to requests for quotations; and
said web server component responsive to the rating engine component to download a quotation display page to said one of the client computers, the quotation display page including at least a first quotation section for presenting a first insurance coverage premium quotation to a user of said one of the client computers, the first insurance coverage premium quotation based on a first set of input rating information, the quotation display page further including at least a first proposal section for presenting at least a first option to generate a customized proposal including details of said at least first insurance coverage premium quotation.

2. The computer system of claim 1, wherein the quotation display page further includes at least a second quotation section for presenting a second insurance coverage premium quotation to said user of said one of the client computers, the second insurance coverage premium quotation based on a second set of input rating information, wherein the quotation display page further includes at least a second proposal section for presenting at least a second option to generate a customized proposal including details of said at least first insurance coverage premium.

3. The computer system of claim 1, wherein the quotation display page further includes at least a second quotation section for presenting a second insurance coverage premium quotation to said user of said one of the client computers, the second insurance coverage premium quotation based on a second set of input rating information, wherein the at least first proposal section presenting an option to generate details of said at least first and said at least second insurance coverage premiums.

4. The computer system of claim 1, wherein said web server component is responsive to a selection of said at least first option to generate a customized proposal by generating a proposal creation page, the proposal creation page generated based at least in part on information associated with said insurance coverage premium quotation.

5. The computer system of claim 4, wherein the proposal creation page is further generated at least in part on information associated with said prospective insured.

6. The computer system of claim 4, wherein the proposal creation page is further generated at least in part on information associated with a role of a user operating said one of the client computers.

7. The computer system of claim 4, wherein the proposal creation page is generated to include a number of sections, including a marketing section presenting marketing options that, if selected cause information associated with said one or more marketing offers to be included in said customized proposal.

8. The computer system of claim 7, wherein information associated with said one or more marketing options includes a title of at least a first marketing material, said at least first marketing material identified by said web server component based at least in part on information associated with said first insurance coverage premium quotation.

9. The computer system of claim 4, wherein the proposal creation page is further generated to include a billing section presenting billing options that, if selected cause information associated with said one or more billing options to be included in said customized proposal.

10. The computer system of claim 9, wherein selection of said billing options causes the billing and fee schedule to be included in said customized proposal, said billing and fee schedule detailing at least a first schedule of payments to be made on said proposed insurance policy.

11. The computer system of claim 10, wherein said billing and fee schedule is calculated based on information associated with said insurance coverage premium quotation and said prospective insured.

12. The computer system of claim 4, wherein the proposal creation page is further generated to include an upsell section presenting one or more upsell options that, if selected cause information associated with said one or more upsell options to be included in said customized proposal.

13. The computer system of claim 4, wherein the proposal creation page is further generated to include a customization section presenting one or more customization options that, if selected enable a user of the client device to enter one or more items to customize an appearance of said customized proposal.

14. The computer system of claim 1, wherein said web server component is responsive to a selection received from said client device to generate a customized proposal by assembling a plurality of proposal sections based on options selected by a user of said client device, said customized proposal presented to said user of said device in a review mode, said review mode enabling said user to edit selected sections of said customized proposal prior to transmitting said customized proposal to said prospective insured.

15. The computer system of claim 14, wherein said selected sections that may be edited by said user are selected based on a type of said section and a role of said user.

16. The computer system of claim 14, further comprising:
transmitting said customized proposal to said prospective insured.

17. The computer system of claim 1, wherein an underwriting questions service application is associated with the web server component and is further operative to select questions for display to said user based at least in part on a classification of said prospective insured selected by said user.

18. The computer system of claim 17, wherein said customer classification is selected by said user by interacting with a classification tool presenting a plurality of options to said user based on information associated with a business of said prospective insured.

19. The computer system of claim 1, wherein the first insurance coverage premium quotation relates to personal or commercial motor vehicle insurance.

20. The computer system of claim 1, wherein the first insurance coverage premium quotation relates to workers' compensation insurance.

21. The computer system of claim 1, wherein the first insurance coverage premium quotation relates to business owners insurance.
